(19) United States
(12) Patent Application Publication
(10) Pub. No.: US 2016/0042661 A1
(43) Pub. Date: Feb. 11, 2016

(54) SYSTEMS AND METHODS FOR TEACHING A TARGET LANGUAGE

(71) Applicants: Seth MINKOFF, Somerville, MA (US); Jesse GRANT, Needham, MA (US)

(72) Inventors: Seth MINKOFF, Somerville, MA (US); Jesse GRANT, Needham, MA (US)

(21) Appl. No.: 14/782,647

(22) PCT Filed: Apr. 8, 2014
(86) PCT No.: PCT/US2014/033335

§ 371 Date: Oct. 6, 2015

Related U.S. Application Data
(60) Provisional application No. 61/809,814, filed on Apr. 8, 2013.

(51) Int. Cl. G09B 19/06; G09B 7/00; G09B 5/06

(52) U.S. Cl. CPC G09B 19/06; G09B 5/06; G09B 7/00

(57) ABSTRACT

In one aspect, a method for teaching a target language to a user is disclosed including: (i) selecting visual representations from a visual representation database corresponding to instructional-language text or images to be displayed on a user interface device; (ii) generating one or more instructions configured to cause the user interface device to display instructional language text or images based on the selected visual representations; (iii) selecting target language audio forms from an audio form database corresponding to respective ones of the selected visual representation; (iv) generating one or more instructions configured to cause the user interface device to play one of the selected audio forms; (v) receiving a user selection of a visual representation from the user interface device; and (vi) determining if the user selection of the visual representation correctly corresponds to the audio form played in step (iv).

### CROSS REFERENCE TO RELATED APPLICATIONS

The present application claims priority to U.S. Provisional Patent Application Ser. No. 61/809,814 filed Apr. 8, 2013, the entire contents of which are incorporated herein by reference.

### BACKGROUND

Students can learn a foreign language by repeatedly being presented with aural or written content in the foreign language along with content either that they already know in their native (or other) language, or that takes the form of a visual image or images whose meaning they readily grasp. However, the type of content that can be used to teach the foreign language is often severely limited, lacks sufficient context, and fails to hold students' interest. It is therefore desirable to develop methods and systems for teaching a foreign language that can include many different types of content and can be made interesting to students of various backgrounds.

### SUMMARY

In one aspect, a method for teaching a target language to a user is disclosed including: (i) selecting visual representations from a visual representation database corresponding to instructional-language text or images to be displayed on a user interface device; (ii) generating one or more instructions configured to cause the user interface device to display instructional language text or images based on the selected visual representations; (iii) selecting target language audio forms from an audio form database corresponding to respective ones of the selected visual representation; (iv) generating one or more instructions configured to cause the user interface device to play one of the selected audio forms; (v) receiving a user selection of a visual representation from the user interface device; and (vi) determining if the user selection of the visual representation correctly corresponds to the audio form played in step (iv).

Some embodiments include, based on the determination in step (vi): adjusting a user known score corresponding to a selected visual representation and a respective audio form; and generating instructions to cause the user interface device to produce an audio or visual indication of whether the user selection of the visual representation correctly corresponds to the audio form played in step (iv).

Some embodiments include: prior to step (ii), for each of the selected visual representations, determining whether a respective user known score for the visual representation is above a replacement threshold; and for selected visual representations having respective user known scores above a replacement threshold, modifying the instructions generated in step (ii) to cause the corresponding instructional-language text or images to be replaced with direct target language transcriptions.

Some embodiments include: iteratively repeating steps (iii) through (vi) where, for each iteration of step (v), the respective one of the selected audio forms is chosen by: (a) identifying an initial audio form choice from the selected audio forms; (b) determining if a user known score corresponding to the initial audio form and respective visual representation is below a teaching threshold; (c) if the user known score corresponding to the initial audio form and respective visual representation is below a teaching threshold, playing the audio form; and (d) if the user known score corresponding to the initial audio form and respective visual representation is not below a teaching threshold, selecting a different initial audio form choice from the selected audio forms and returning to step (b).

Some embodiments include: determining if a user known score corresponding to the audio form to be played in step (iv) is below a hint threshold; and if a user known score corresponding to the audio form to be played in step (iv) is below the hint threshold, generating instructions to cause the user interface device to visually identify the respective visual representation while or after the audio form is played.

In some embodiments, iteratively repeating steps (iii) through (vi) further includes: monitoring a user known score for each of the selected visual representations and respective audio forms; and ending the iterative repetition of steps (iii) through (vi) when the user known score for each of the selected visual representations and respective audio forms is above the teaching threshold.

In some embodiments, user known score for each of the selected visual representations and respective audio forms is determined based on at least one selected from the list consisting of: the number of times the user correctly identifies the visual representation in response to the corresponding audio form; a speed at which the user correctly identifies the visual representation in response to the corresponding audio form; the number of times the user has heard the audio form; the amount of time that has lapsed since the last time the user has heard the audio form.

Some embodiments include, after ending the iterative repetition of steps (iii) through (vi): (vii) selecting a discourse portion from a discourse selection database, the discourse portion corresponding to a first set of visual representations in a respective correct order; (viii) generating one or more instructions configured to cause the user interface device to display instructional language text or images corresponding to the first set of visual representations in a display order that is different from the respective correct order; (ix) selecting target language audio forms from an audio form database corresponding to respective ones of the first set of visual representations; (x) generating one or more instructions configured to cause the user interface device to play an audio form for a respective visual representation from the first set of visual representations; (xi) receiving a user selection of a visual representation from the user interface device; and (xii) determining if the user selection of the visual representation correctly corresponds to the audio form played in step (x).

Some embodiments include, based on the determination in step (xii): adjusting a user known score corresponding to a pairing of a selected visual representation and a respective audio form; and generating instructions to cause the user interface device to produce an audio or visual indication of whether the user selection of the respective visual representation correctly corresponds to the audio form played in step (x).

In some embodiments, the first set of visual representations may include one or more of the visual representations selected in step (i).

Some embodiments include iteratively repeating steps (x)-(xii) where, if it is determined in a first iteration of step (xii) that the user selection of the visual representation correctly corresponds to the audio form played in the preceding step (x), in the next iteration a new audio form is selected for the next iteration of step (x) based on the correct order of the discourse portion.

Some embodiments include ending the iterative repetition of steps (x)-(xii) when the user has correctly identified each visual representation of the first set of visual representations.

Some embodiments include: (xiii) selecting a second discourse portion from a discourse selection database, the second discourse portion corresponding to a second set of visual representations in a respective correct order; (xiv) generating one or more instructions configured to cause the user interface device to display instructional-language text or images corresponding to the second set of visual representations in a display order that is different from the respective correct order; (xv) selecting target language audio forms from an audio form database corresponding to respective visual representations of the second set of visual representations; (xvi) generating one or more instructions configured to cause the user interface device to play an audio form for a respective visual representation from the second set of visual representations; xvii) receiving a user selection of a visual representation from the user interface device; and (xviii) determining if the user selection of the visual representation correctly corresponds to the audio form played in step (xvi).

Some embodiments include: generating one or more instructions configured to cause the user interface device to display text or images corresponding to the first discourse portion and the second discourse portion; receiving a user selection of the first discourse portion or the second discourse portion; and generating instructions to cause the user interface device to review the selected discourse portion by sequentially displaying text or images based on the set of visual representations for the selected discourse portion in an order corresponding to the correct order.

Some embodiments include playing the respective audio form for each of the visual representations during the step of sequentially displaying or otherwise visually indicating text or images based on the set of visual representations for the selected discourse portion in an order corresponding to the correct order.

In some embodiments, the first discourse portion and the second discourse portion are each sentences in a common discourse.

In some embodiments, playing the respective audio form for each of the visual representations during the step of sequentially displaying or otherwise visually indicating text or images based on the set of visual representations for the selected discourse portion in an order corresponding to the correct order includes playing the respective audio forms and displaying the text or images at a user selected tempo.

In some embodiments, the user interface device includes at least one from the list consisting of: a cellular phone, a smart phone, a tablet computer, a laptop computer, a personal computer, and a television.

In some embodiments, the instructional language is English and the target language includes at least one from the list consisting of: Arabic, Spanish, French, German, Italian, Russian, Hindi, Japanese, and Chinese.

In another aspect, a non-transitory computer readable storage medium is disclosed. In various embodiments, the medium includes instructions which when executed by a processor implements the steps of any of the methods described above.

In another aspect, an apparatus for teaching a target language to a user is disclosed including: at least one processor in operative communication with a user interface device; a visual representation database in operative communication with at least one processor: and an audio form database in operative communication with at least one processor. In some embodiments, during operation the processor is configured to: (i) select visual representations from a visual representation database corresponding to instructional-language text or images to be displayed on a user interface device; (ii) generate one or more instructions configured to cause the user interface device to display instructional language text or images based on the selected visual representations; (iii) select target language audio forms from an audio form database corresponding to respective ones of the selected visual representation; (iv) generate one or more instructions configured to cause the user interface device to play one of the selected audio forms; (v) receive a user selection of a visual representation from the user interface device; and (vi) determine if the user selection of the visual representation correctly corresponds to the audio form played in step (iv).

Some embodiments include an evaluation module in operative communication with the processor, and configured to, based on the determination in step (vi): adjust a user known score corresponding to a selected visual representation and a respective audio form; and cause the processor to generate instructions to cause the user interface device to produce an audio or visual indication of whether the user selection of the visual representation correctly corresponds to the audio form played in step (iv).

In some embodiments, the evaluation module is configured to: prior to step (ii), for each of the selected visual representations, determine whether a respective user known score for the visual representation is above a replacement threshold; and for selected visual representations having respective user known scores above a replacement threshold, cause the processor to modify the instructions generated in step (ii) to cause the corresponding instructional-language text or images to be replaced with direct target language transcriptions.

In some embodiments, the apparatus is configured to: iteratively repeat steps (iii) through (vi) where, for each iteration of step (v), the respective one of the selected audio forms is chosen by: (a) identifying an initial audio form choice from the selected audio forms; (b) determining if a user known score corresponding to the initial audio form and respective visual representation is below a teaching threshold; (c) if the user known score corresponding to the initial audio form and respective visual representation is below a teaching threshold, playing the audio form; and (d) if the user known score corresponding to the initial audio form and respective visual representation is not below a teaching threshold, selecting a different initial audio form choice from the selected audio forms and returning to step (b).

In some embodiments, the evaluation module is configured to: determine if a user known score corresponding to the audio form to be played in step (iv) is below a hint threshold; and if a user known score corresponding to the audio form to be played in step (iv) is below the hint threshold, cause the processor to generate instructions to cause the user interface device to visually identify the respective visual representation while or after the audio form is played.

In some embodiments, the evaluation module is configured to: monitor a user known score for each of the selected visual representations and respective audio forms; and cause the processor to end the iterative repetition of steps (iii) through (vi) when the user known score for each of the selected visual representations and respective audio forms is above the teaching threshold.

In some embodiments, the user known score for each of the selected visual representations and respective audio forms is determined based on at least one selected from the list consisting of: the number of times the user correctly identifies the visual representation in response to the corresponding audio form; a speed at which the user correctly identifies the visual representation in response to the corresponding audio form; the number of times the user has heard the audio form; the amount of time that has lapsed since the last time the user has heard the audio form.

Some embodiments include a discourse selection database in operative communication with the processor. In some embodiments, the processor is further configured to, after ending the iterative repetition of steps (iii) through (vi): (vii) select a discourse portion from a discourse selection database, the discourse portion corresponding to a first set of visual representations in a respective correct order; (viii) generate one or more instructions configured to cause the user interface device to display instructional language text or images corresponding to the first set of visual representations in a display order that is different from the respective correct order; (ix) select target language audio forms from an audio form database corresponding to respective ones of the first set of visual representations; (x) generate one or more instructions configured to cause the user interface device to play an audio form for a respective visual representation from the first set of visual representations; (xi) receive a user selection of a visual representation from the user interface device; (xii) determine if the user selection of the visual representation correctly corresponds to the audio form played in step (x).

In some embodiments the evaluation module is configured to, based on the determination in step (xii): adjust a user known score corresponding to a pairing of a selected visual representation and a respective audio form; and generate instructions to cause the user interface device to produce an audio or visual indication of whether the user selection of the respective visual representation correctly corresponds to the audio form played in step (x).

In some embodiments, the first set of visual representations may include one or more of the visual representations selected in step (i).

In some embodiments, the apparatus is configured to: iteratively repeat steps (x)-(xii) where, if it is determined in a first iteration of step (xii) that the user selection of the visual representation correctly corresponds to the audio form played in the preceding step (x), in the next iteration a new audio form is selected for the next iteration of step (x) based on the correct order of the discourse portion.

In some embodiments, the evaluation module is configured to cause the processor to end the iterative repetition of steps (x)-(xii) when the user has correctly identified each visual representation of the first set of visual representations.

In some embodiments, the apparatus is further configured to: (xiii) select a second discourse portion from a discourse selection database, the second discourse portion corresponding to a second set of visual representations in a respective correct order, (xiv) generate one or more instructions configured to cause the user interface device to display instructional-language text or images corresponding to the second set of visual representations in a display order that is different from the respective correct order; (xv) select target language audio forms from an audio form database corresponding to respective visual representations of the second set of visual representations; (xvi) generate one or more instructions configured to cause the user interface device to play an audio form for a respective visual representation from the second set of visual representations; (xvii) receive a user selection of a visual representation from the user interface device; and (xviii) determine if the user selection of the visual representation correctly corresponds to the audio form played in step (xvi).

In some embodiments, the apparatus is further configured to: generate one or more instructions configured to cause the user interface device to display text or images corresponding to the first discourse portion and the second discourse portion; receive a user selection of the first discourse portion or the second discourse portion; and generate instructions to cause the user interface device to review the selected discourse portion by sequentially displaying text or images based on the set of visual representations for the selected discourse portion in an order corresponding to the correct order.

In some embodiments, the user interface device includes at least one from the list consisting of: a cellular phone, a smart phone, a tablet computer, a laptop computer, a personal computer, and a television. Some embodiments also include user interface device.

In various embodiments the apparatus may automate any of the methods (or steps thereof) described above.

The present disclosure also provides systems and methods for teaching a target language. In one aspect, a method for teaching a language is disclosed. The method may include the step of selecting instructional language visual representations to be displayed. The method may include the step of replacing the content of any selected visual representation with a direct target language transcription of its corresponding target language audio form, if the known score of that particular visual representation/target-language audio form pairing is sufficiently high. In some embodiments, the method includes the step of displaying visual representations in the form of instructional language text, or of images whose meanings are readily grasped, or of target language text (given sufficiently high known scores in the previous step). In some embodiments, the method includes the step of selecting target-language audio forms to start teaching. In some embodiments, the method includes the step of selecting a single target-language audio form and its accompanying visual representation from the audio forms selected previously. In some embodiments the method includes the step of determining whether the user's “known score” for the selected audio form/visual representation pair is low enough that the selected audio for/visual representation pair must be taught. In some embodiments, if it is determined that the known score is high enough so that there is no need to teach the selected audio form/visual representation pair, the method includes the step of determining whether there are additional audio form/visual representation pairs left with known scores low enough that these pairs must be taught, and, if there are, then selecting one of these at random. In some embodiments, if it is determined that the audio form/visual representation pair must be taught, the method includes the step of audibly presenting the audio form to the user.

In some embodiments, the method includes the step of determining whether the “known score” for this audio form/visual representation pair is sufficiently low that the user needs assistance to select the correct visual representation after hearing the audio form. In some embodiments, if the known score is low enough, the method includes the step of visually indicating the correct visual representation corresponding to the target language audio form. In some embodiments, if the known score is high enough that the user does not require additional assistance, the method includes the step of providing no visual indication.

In some embodiments, the method includes the step of recording the user's selection of the visual representation the user believes corresponds to the audio form, and determining whether the selection was correct. In some embodiments, if the selection is correct, the method includes the step of increasing the user's known score for that audio form/visual representation pair, and of providing the user with a visual indication that the selection is correct. In some embodiments, if the selection is not correct, the method includes the step of decreasing the user's known score for that audio form/visual representation pair, and the step of providing the user with a visual indication of the correct selection. In some embodiments, if, after choosing incorrectly, the user is provided with a visual indication of the correct selection, the method includes recording the user's selection of the visual representation the user now believes to be correct. In some embodiments, the method also includes the step of determining whether the audio form/visual representation pair has been taught a sufficient number of times.

Various implementations may include any of the above described devices, techniques, and elements thereof, either alone or in any suitable combination.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing.

FIG. 1 is an example system for teaching a target language, according to an illustrative implementation.

FIGS. 2A-2L are depictions of a graphical user interface 200 for teaching a target language, according to an illustrative implementation.

FIG. 3 is a block diagram of a method for causing a user of a computing device to store a limited number of target language words and phrases in short-term memory, according to an illustrative implementation.

FIG. 4 is a block diagram of a method for teaching a user to construct a discourse or discourse portion, such as a sentence, composed of the target language words and phrases stored in short-term memory in the method of FIG. 3, according to an illustrative implementation.

FIG. 5 is a block diagram of a method for allowing a user to hear and read again prior sentences or possibly other discourse portions in the discourse constructed in the method of FIG. 4, by selecting them from a list of such discourse portions.

FIG. 6 is a depiction of a graphical user interface 200 for teaching a target language, according to an illustrative implementation.

FIG. 7 is a depiction of a graphical user interface 200 for teaching a target language, according to an illustrative implementation.

FIGS. 8A-8C are depictions of a graphical user interface 200 for teaching a target language, according to an illustrative implementation.

FIG. 9 is a depiction of a teacher dashboard interface, according to an illustrative implementation.

FIG. 10 is a depiction of a user page interface, according to an illustrative implementation.

### DETAILED DESCRIPTION

Following below are more detailed descriptions of various concepts related to, and implementations of, methods and systems for teaching a target language. The various concepts introduced above and discussed in greater detail below may be implemented in any of numerous ways, as the described concepts are not limited to any particular manner of implementation. Examples of specific implementations and applications are provided primarily for illustrative purposes.

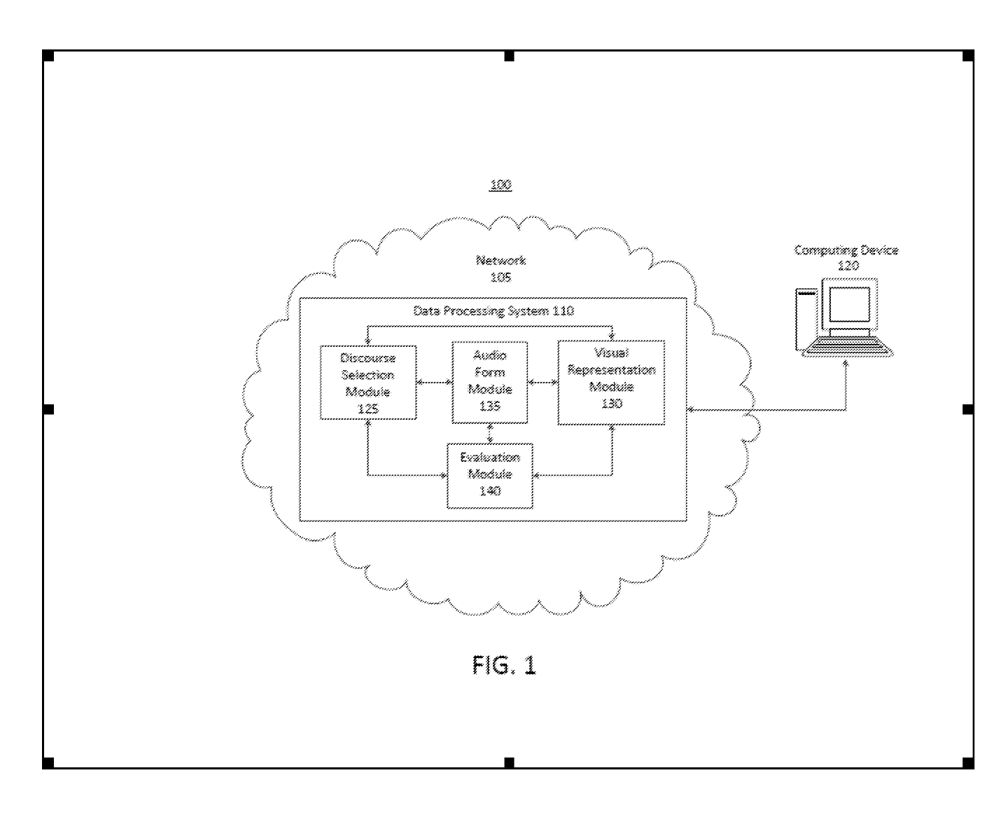

FIG. 1 is an example system 100 for teaching a target language, according to an illustrative implementation. The system 100 can include a computing device 120 (e.g., a user interface device), which can be used by a student of the target language. The system 100 can also include a data processing system 110 having a discourse selection module 125, an audio form module 135, a visual representation module 130, and an evaluation module 140. The elements of the system 100 can communicate via the network 105.

Content can be presented to a user of the computing device 120 in the target language as well as in a language in which the user is already proficient (referred to herein as the instructional language or native language). The content can be delivered to the computing device 120 in any form, such as audio, video, still images, or text, and can be presented in a manner that allows the user to gradually learn the target language. The data processing system 110 can determine the user's level of proficiency in the target language. New target language content can then be presented as the user's target language proficiency increases.

The data processing system 110 can present content to the user of the computing device 120 as part of a discourse. A discourse can be any group of related words in the target language. For example, a discourse can be a phrase, a sentence, a paragraph, a short story, a dialogue, a joke, a poem, an essay, or any other grouping of words in the target language. There may be more than one discourse available to be presented to the user of the computing device 120. The discourse selection module 125 can select one discourse to be presented to the user from all available discourses (e.g., stored in a discourse database included in or in communication with the discourse selection module). For example, the discourse selection module 125 can choose a discourse based on an interest or proficiency level of the user of the computing device 120.

In one implementation, the discourse selection module 125 can determine that the user of the computing device 120 has a low level of proficiency in the target language. For example, the data processing system 110 can prompt the user of the computing device 120 to answer questions about his or her proficiency level, and the discourse selection module 125 can determine the proficiency level of the user based on the user's responses. Alternatively, the data processing system 110 can prompt the user of the computing device 120 to attempt to identify the meanings of a sample of target language words. Based on the user's responses, a proficiency level can be determined according to the level of complexity of the target language words and the accuracy of the user's responses. The discourse selection module 125 can use the proficiency level to select a discourse for the user. In one implementation, the proficiency level can be determined by the evaluation module 140.

A target language proficiency level can also be determined based on the amount of time the user has devoted to learning the target language. For example, a user who has spent little or no time learning the target language can be determined to have a low level of proficiency in the target language. The discourse selection module 125 can then select a discourse whose language is suitable for a beginner. A user who has spent a significant amount of time learning the target language can be determined to have a higher level of proficiency, and the discourse selection module 125 can select a discourse having more challenging language. For example, the user's proficiency level can be determined by the number of discourses that have been presented to the user previously, as well as the language level of those discourses. Thus, the discourse selection module 125 can select increasingly challenging discourses as the user becomes more familiar with words in the target language.

In some implementations, the discourse selection module 125 can select a discourse to be presented to a user of the computing device 120 based in part on the interests of the user. For example, the user can be prompted to enter information related to his or her interests. The user can also be prompted to enter demographic information, such as the user's age, gender, career, or location. The discourse selection module 125 can then use the information supplied by the user to determine the user's interests, and can select a discourse that is related to those interests. For example, a user can provide information indicating an interest in sports. The discourse selection module 125 can then select a discourse related to sporting events. If the user also supplies information related to the user's location, the discourse selection module 125 can use the location information to determine the discourse that is selected. For example, the discourse selection module 125 can select a discourse related to a sports team based near the user's location.

After a discourse has been selected for the user, the data processing system 110 can present language from the discourse to the user in a manner that allows the user to learn the meanings of target language words in the discourse and to store the target language words in the user's short-term memory. For example, the data processing system 110 can deliver an array of visual representations of the meanings of target language words for display at the computing device 120. A visual representation can be an image, a video, text in the instructional language, or any other type of visual representation that conveys the meaning of a target language word or phrase in a way that the user of the computing device 120 can easily comprehend. For any target language words that the user knows well enough (e.g., as determined by comparing a user proficiency score related to the words to a threshold score), a visual representation can be text in the target language. The visual representations can be selected and delivered to the computing device 120 by the visual representation module 130 via the network 105. Audio forms can also be delivered to the computing device 120. For example, audio forms can be aural content in the target language. The audio form module 135 can determine audio forms that are part of the selected discourse and deliver the audio forms to the computing device 120 via the network 105. The audio forms can then be presented or “played” (e.g., in the target language) to a user of the computing device 120, for example using a speaker or other audio output of the computing device 120.

Each discourse can have content in the target language as well as corresponding content in the instructional language, or in the form of a visual image or images. The target language words and instructional language words, or visual images, for a discourse can be stored by the data processing system 110 in a hierarchical data structure. For example, the content can be stored by the discourse selection module 125, or by a storage element, such as a database, associated with the data processing system 110. In some implementations, the content may be stored in XML documents.

Each target language word or phrase can be paired with its equivalent instructional language word or phrase or visual image. For example, a one-to-one correspondence of such pairs can be created. The paired words and phrases and/or images can then be stored in the hierarchical data structure maintained by the data processing system 110. In some implementations, the order in which the pairs are stored in the data structure can match the order in which they appear in the discourse.

In some implementations, a pair can include a single target language word and a single instructional language word. In other implementations, a pair may contain more than one word from either the target language or the instructional language, or both. Allowing for multiple words in a single pair can help to maintain the one-to-one correspondence of target language and instructional language content in instances where the two languages have syntactic differences. For example, the Spanish phrase “te amo” and the English phrase “I love you” have equivalent meanings, but the effective Spanish order is “you I love,” and thus the English and Spanish word orders cannot both be maintained without violating a one-to-one correspondence relation between individual words. In order to retain the orders required by English and Spanish, the entire contents of these two syntactically distinct strings are placed in a one-to-one-correspondence pair. No such relation is maintained between the individual words of which these strings are composed.

In other implementations, syntactic differences between the target language and instructional language can be minimized by the use of constructions with pleonastic subjects. For example, the target language Spanish sentence “Apareció una mujer” translates as the instructional language English sentence “A woman appeared,” but these are syntactically distinct since the effective Spanish word order is “appeared a woman.” This distinction is minimized by translating “apareció” and “una mujer” separately as “there appeared” and “a woman,” respectively, and placing each of these within distinct one-to-one-correspondence pairs, so that a finer-grained one-to-one correspondence of target- and instructional language terms is maintained, and the English is rendered as “there appeared a woman,” which is syntactically closer to the Spanish.

In addition to including defined pairs as discussed above, the hierarchical data structure can include other elements. For example, the hierarchical data structure can include phrases, which can be defined by groups of word pairs. Furthermore, phrases can be grouped in the data structure to define a sentence. A single sentence or multiple sufficiently short sentences can be grouped in the data structure to define a beginner page. Beginner pages can be grouped in the data structure to define an intermediate page. Intermediate pages can be grouped in the data structure to define an advanced page. Other groupings within the data structure are also possible, and there is no limit to the number of defined groups that may be included in a single discourse. These groupings can be used to make content from a discourse relevant to students of varying abilities. For example, if the user of the computing device 120 is a novice student, he or she may only be able to process language presented as paired words or phrases within a single beginner page, while a more experienced student might be able to process content presented as paired entire sentences within a single advanced page.

In order to avoid confusion, when two or more homographic or homonymous terms occur in the same language on the same beginner page, intermediate page or advanced page, one or more of these terms can be combined with other language content. For example, if the target language is Spanish and the words “vino” meaning “came” and “vino” meaning “wine” are associated with the same page, then the latter “vino” might be made distinct from the former by being placed after the Spanish word “el” within a given word pair to yield “el vino,” meaning “the wine.” Thus, the page would include one word pair consisting of the target language “vino” with the instructional language “came,” and a second word pair consisting of the target language “el vino” with the instructional language “the wine.”

The discourse selection module 125 can select a discourse having word pairs whose target language and instructional language content are as etymologically close as possible, in order to facilitate more rapid attainment of fluency on the part of the user of the computing device 120. In one example, if the user is a beginner, the instructional language English word “car” would be paired with the target language Spanish word “carro” rather than “coche,” though these have similar meanings. Similarly, the target language Spanish word “clase” would be paired with the instructional language English word “class” rather than “course,” though these have similar meanings. As the student attains more advanced levels, the discourse selection module 125 can select discourses with word choices that are progressively less determined by etymological proximity.

In some implementations, the discourse selection module 125 can alter a discourse, or select a discourse that has been altered, based on the skill level of the user of the computing device 120. In one example, if the user is a beginner, the discourse selection module 125 can replace less common words in a discourse with more frequently used words, or select a discourse in which less common words have been replaced with more frequently used words, so that the user can gain exposure to the words most commonly used in the target language. For example, the discourse selection module 125 might replace the word “devoured” with its more common synonym “ate”, or select a discourse in which such a replacement has been made, in order to facilitate more rapid attainment of fluency by, e.g., a beginning user.

In some implementations, for users of the computing device 120 who know target language words (e.g., as determined by comparing a user proficiency score related to the words to a threshold score), the discourse selection module 125 can alter a discourse by replacing instructional language text and/or images in visual representations with target language transcriptions of the known target language audio forms. This enables the user who already understands target language words aurally to gain exposure to these words in their written forms, and in this way develop reading ability in the target language.

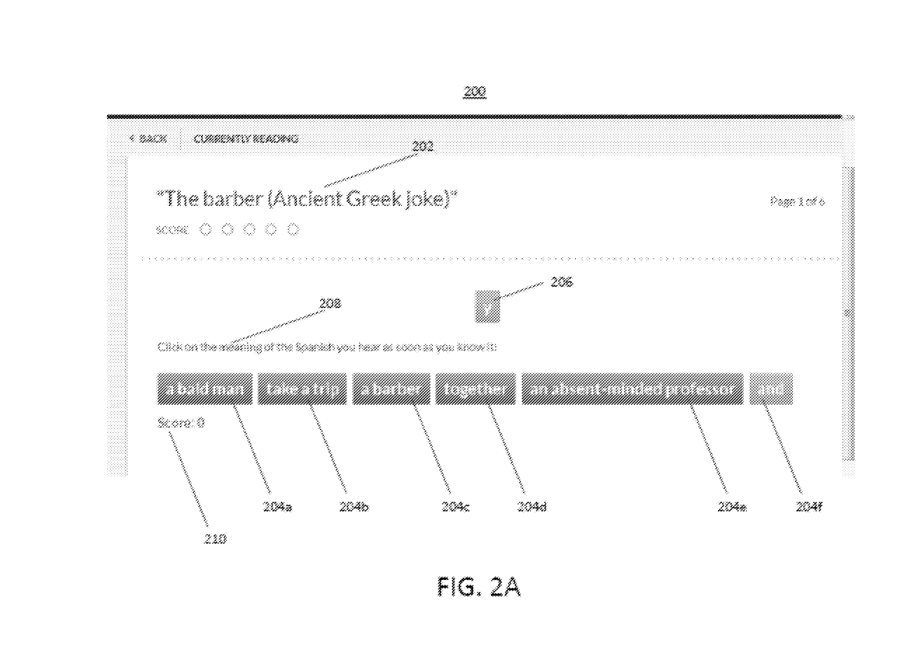

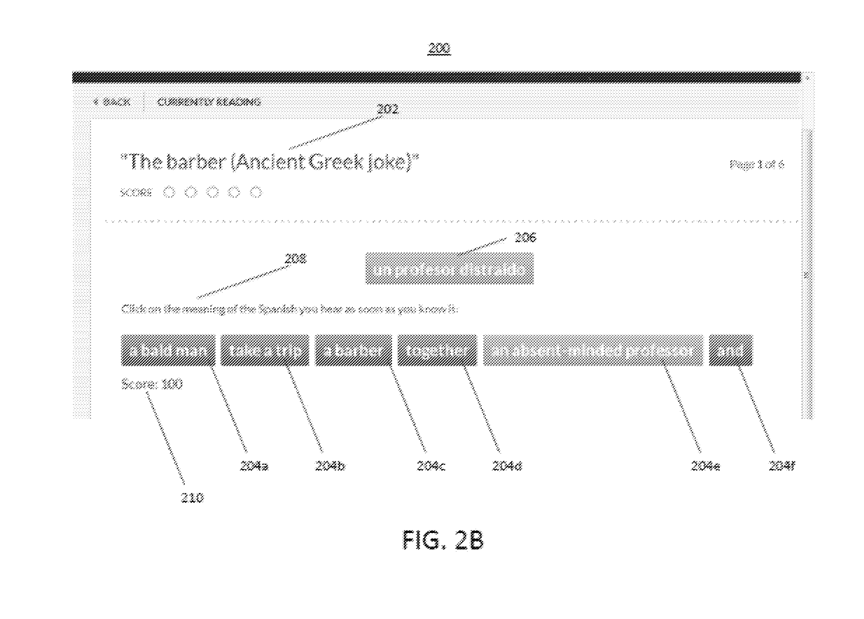

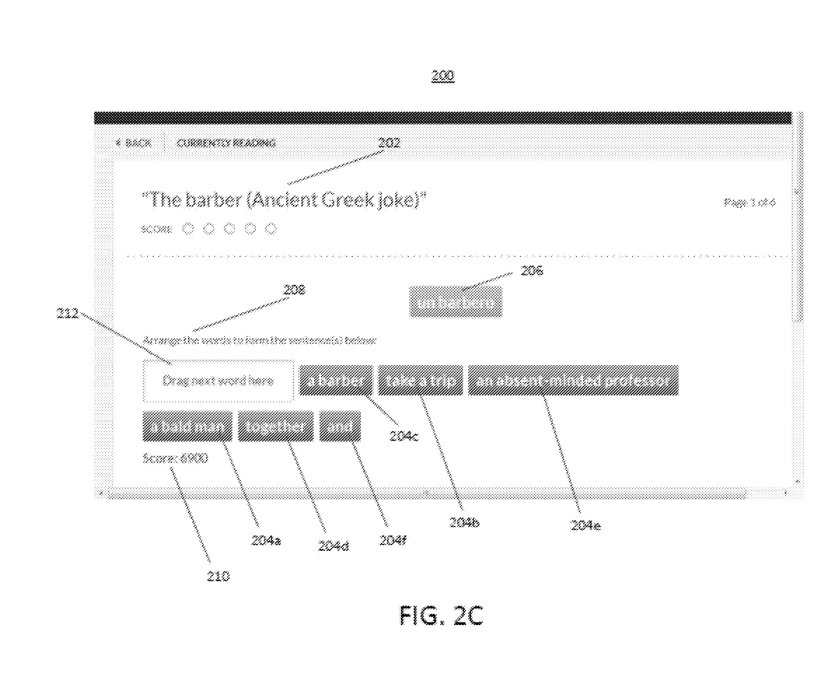

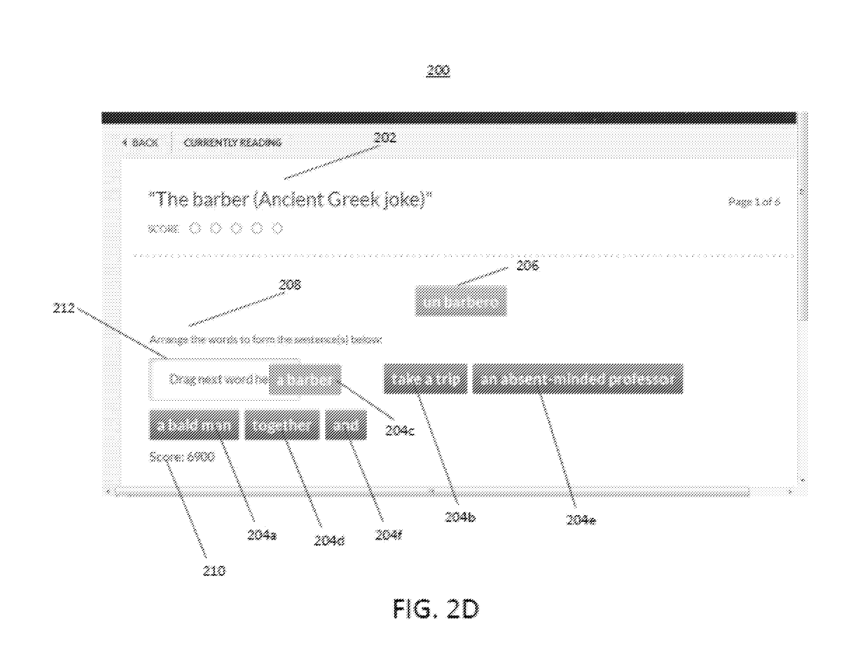

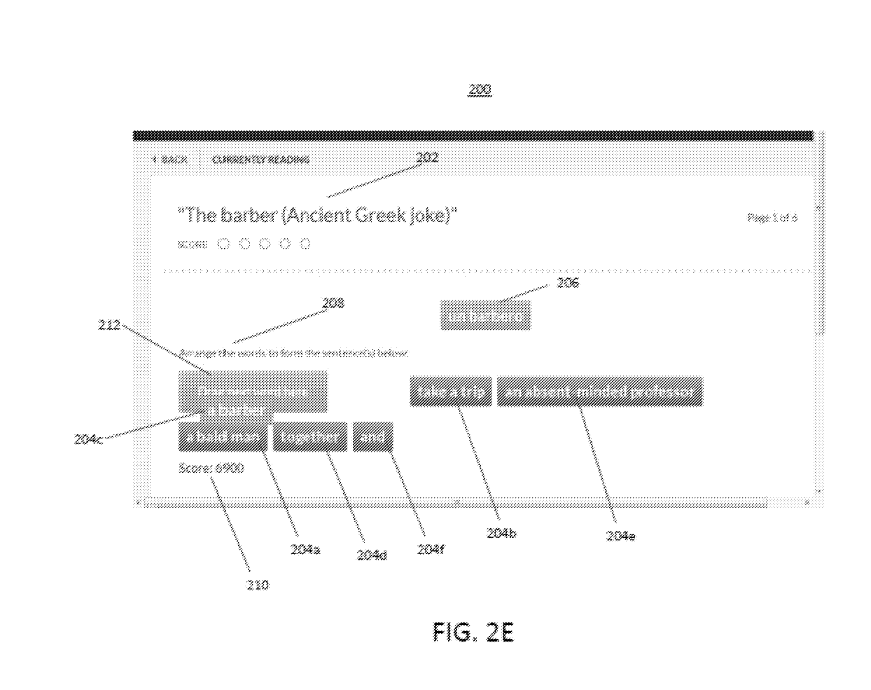

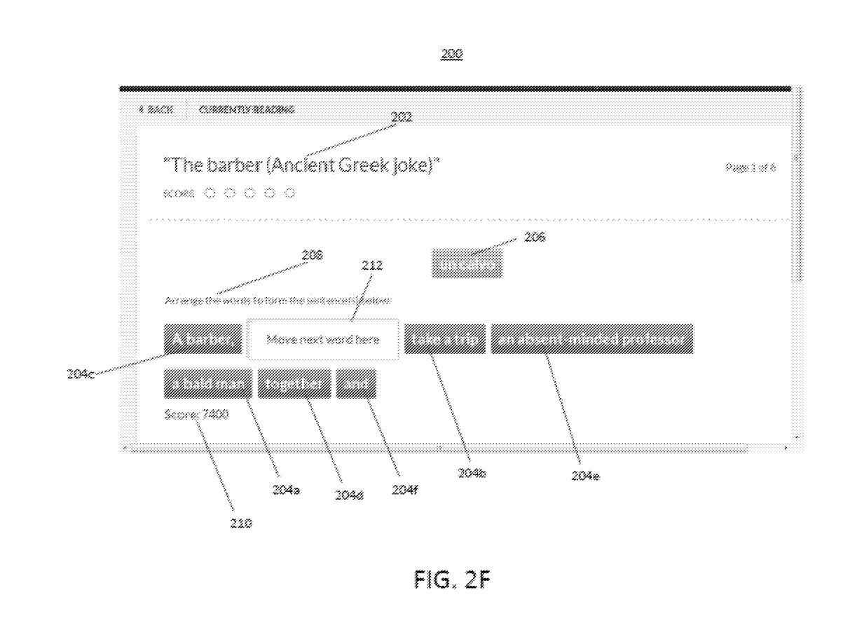

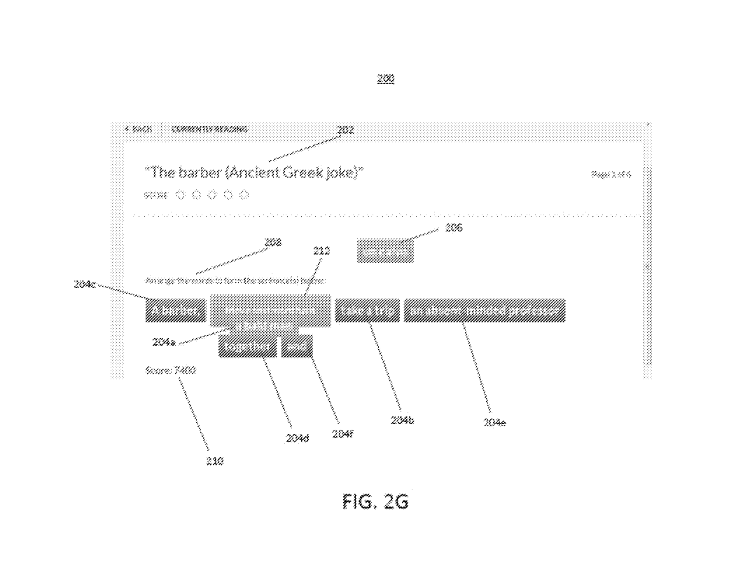

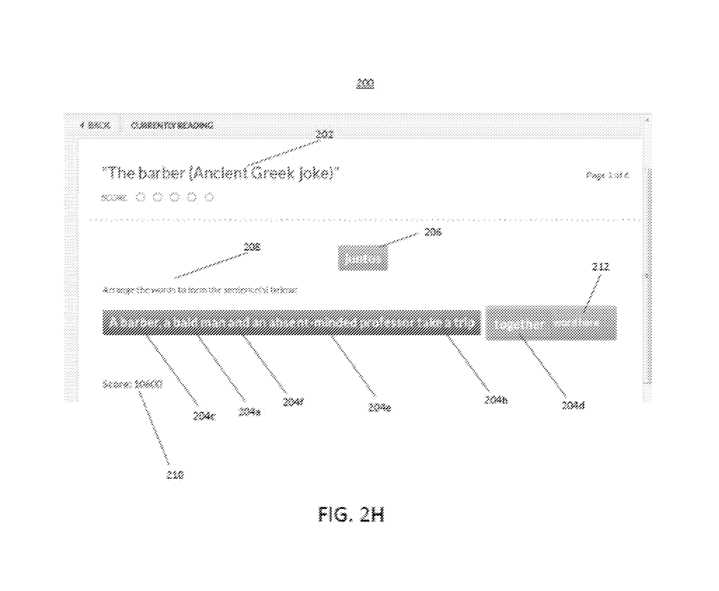

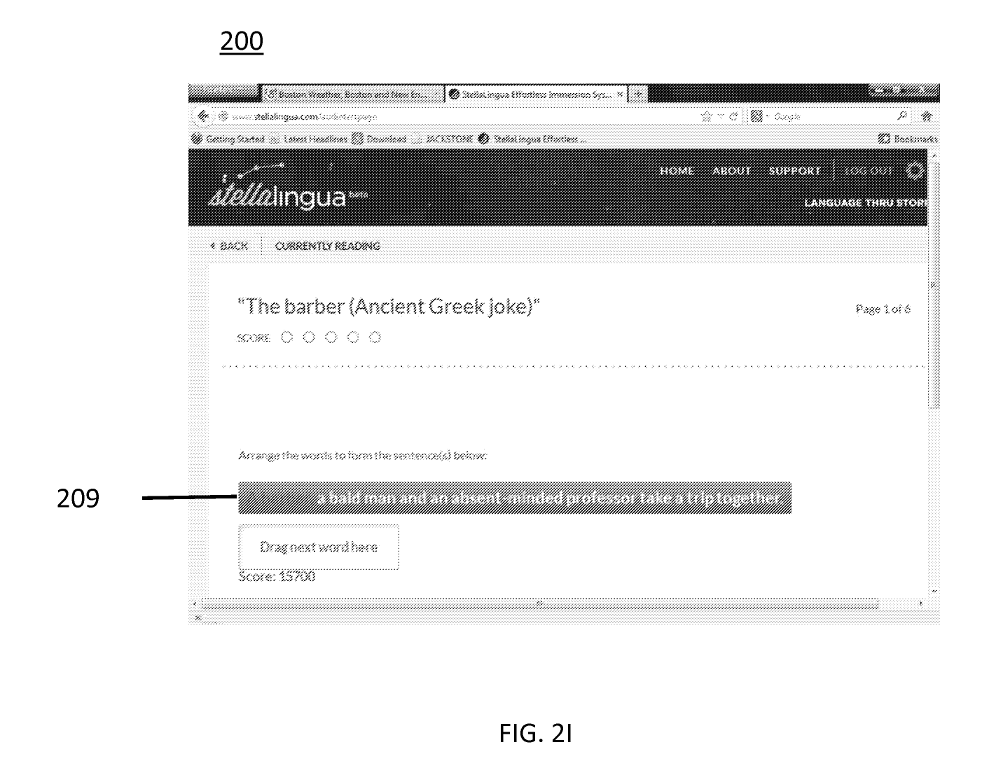

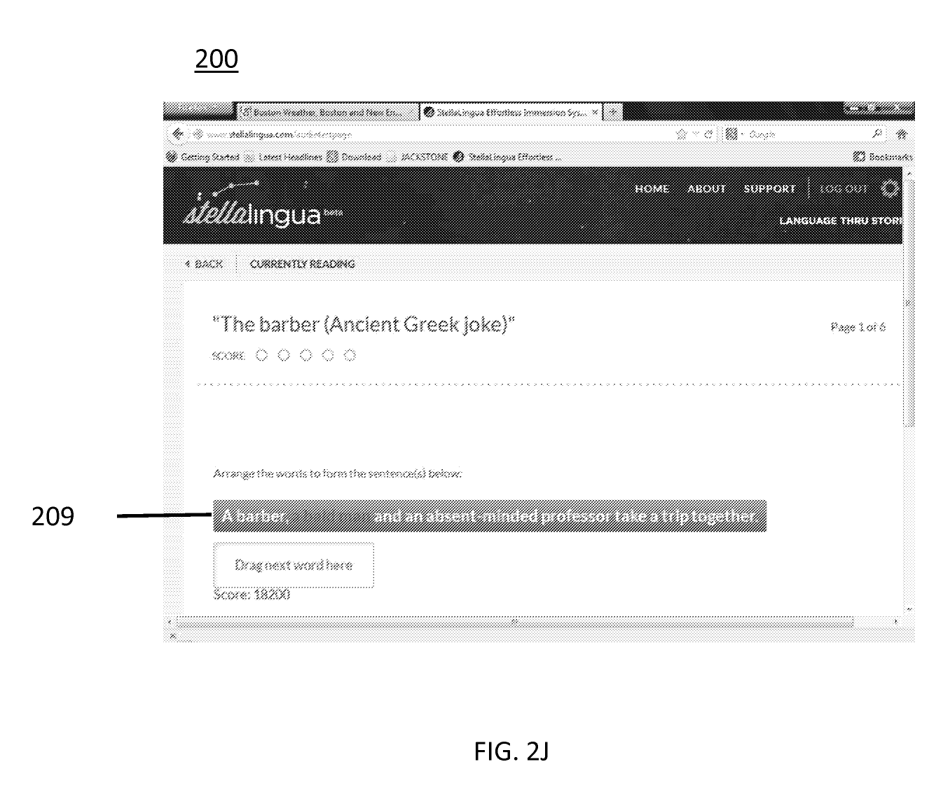

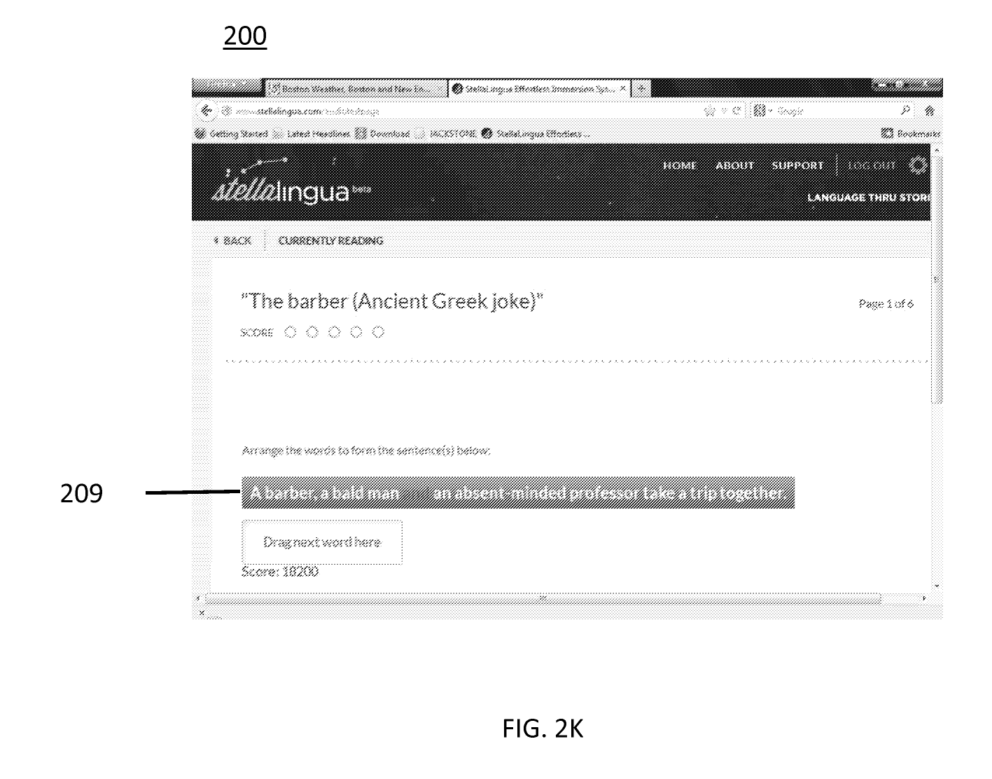

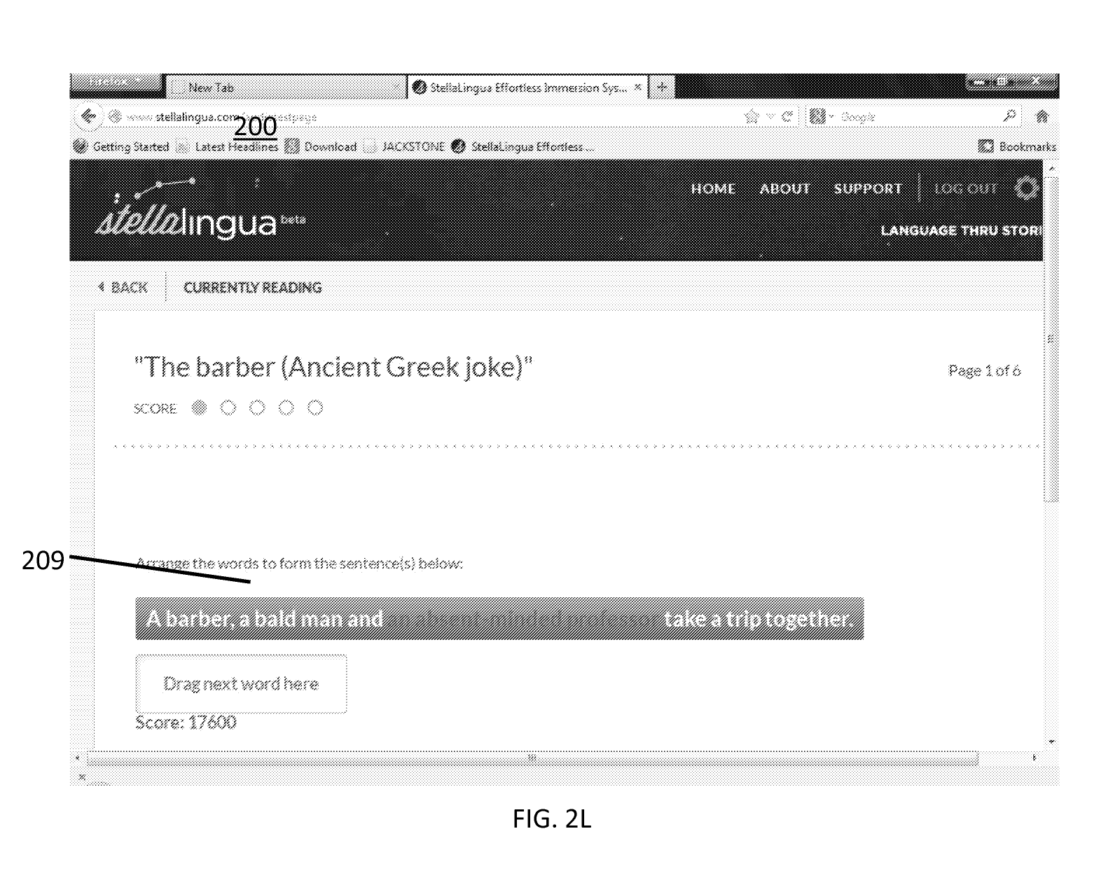

FIGS. 2A-2L, 6, 7 and 8A-C are depictions of a graphical user interface 200 for teaching a target language, according to an illustrative implementation. In the examples shown in FIGS. 2A-2L, 6, 7 and 8A-C, the target language is Spanish and the instructional language is English. The graphical interface 200 can be controlled by the data processing system 110 and displayed on the computing device 120. As shown in FIGS. 2A and 2B, the data processing system 110 can use the graphical user interface 200 in a first mode (“Mode 1”) to help the user to store target language words and phrases in short-term memory. FIGS. 2C-2L show how the graphical user interface can be used in a second mode (“Mode 2”) in which the user constructs a sentence or sentences based on the words stored in short-term memory in Mode 1.

In one implementation of Mode 1, the graphical interface 200 can be used to display instructional- and/or target language words, phrases, or sentences that represent a discourse, or a portion of a discourse, in the target language. In some embodiments, the discourse can be selected by the discourse selection module 125 shown in FIG. 1. As indicated by discourse title 202, the discourse shown in FIG. 2A is a joke titled “The barber.”

In the example graphical interface 200 shown in FIG. 2A, the visual representations 204a-204f are displayed as text in the instructional language (as shown, English). Each visual representation 204 conveys the meaning of a portion of the discourse—more specifically, the meaning of a portion of a sentence that is itself a portion of the larger discourse to be presented to the user of the computing device 120. In other implementations, the visual representations 204a-204f could be displayed in another form, such as an image of the concept to be represented; and for target language words that are known by the user, they could take the form of target language text. The visual representation module 130 can select or generate the visual representations 204 to be displayed. For example, the visual representation module 130 can select an instructional language textual representation when the word or phrase is difficult to represent pictorially. The visual representation module 130 can also take into account the preferences and learning style of the user of the computing device 120. For example, if the user has a history of understanding the target language more quickly when image-based visual representations are used, the visual representation module 130 can increase the frequency with which target language words, phrases, or sentences are visually represented with images.

In some implementations, the visual representations 204 are arrayed in a random order within the graphical user interface 200. For example, visual representations 204a-204f all belong sequentially as part of the discourse, but are presented in random order in FIG. 2A. The random ordering can help to separate the individual meanings of the visual representations 204 from the meaning of the discourse as a whole. Therefore, the user of the computing device 120 can learn the meanings of individual words and phrases in the target language and commit them to short-term memory before applying the newly learned meanings to understand the discourse.

In addition to visual representations 204a-204f, audio forms can also be presented to the user of the computing device 120. An audio form can be an aural presentation, in the target language, of any displayed visual representation 204. In some implementations, an audio form is a recording of a human reader reciting the target language equivalent of a visual representation. An audio form can be presented to allow a user to become familiar with the pronunciation of the target language.

The audio form module 135 can select an audio form (e.g., from an audio form database contained in or in operative communication with the audio form module 135) and can transmit it to the computing device 120 via the network 105. In some implementations, a target language transcription 206 can also be displayed on the graphical user interface 200. (This is distinct from a target language transcription of a visual representation, which can be supplied when the user happens already to know a target language word corresponding to a visual representation.) A target language transcription 206 can be the written form of the word or group of words expressed in audio form. A target language transcription 206 and corresponding audio form can help the user to understand the phonology of the target language. Because each audio form corresponds to a visual representation 204, each target language transcription 206 will also have a corresponding visual representation 204.

In some implementations, the audio form module 135 can randomly select an audio form corresponding to one of the visual representations 204a-204f. The audio form module can then transmit the selected audio form to the computing device 120, where it can be presented to a user through an audio output of the computing device 120, such as a speaker or headphones. While the audio form is being presented to the user, the target language transcription 206 can also be presented and the visual representation module 130 can highlight the corresponding visual representation. For example, as shown in FIG. 2A, the audio form module 135 can select the audio form corresponding to the target language word “y,” which can be aurally presented to the user of the computing device 120. At the same time, the target language transcription 206 can appear on the interface 200, and the corresponding visual representation 204f “and” can be highlighted for the user. Thus, the interface 200 helps the user to understand a target language word, phrase, or sentence by presenting the word, phrase, or sentence aurally through the audio form, presenting a transcription 206 of the word, phrase, or sentence in the target language, and highlighting the visual representation 204f. The user of the computing device 120 can therefore quickly store in short-term memory the meaning, spelling, and sound of the target language word, phrase, or sentence.

The graphical interface 200 can also include a prompt 208 asking the user to indicate that the information conveyed through the audio form, the visual representation 204f, and the target language-transcription 206 is understood. For example, the prompt 208 can ask the user to select the visual representation 204f corresponding to the audio form and the target language transcription 206 as soon as the user understands the meaning of the audio form. The highlighting of the visual representation 204f, which is written in the instructional language, helps the user to quickly understand the meaning of the audio form. This is not intended to challenge the user or to test the user's knowledge of the target language. Rather, it is intended to help the user quickly learn the meanings of target language words, phrases, or sentences by enabling the user to store the information in the user's short-term memory. In some implementations, the visual representation 204f may not be highlighted (e.g., if the user's past activity indicates that the user may already have an understanding of the term represented by the visual representation 204f). For example, in some embodiments, the highlighting of the visual representation 204f may occur if a user proficiency score (e.g., a “known score” as discussed below) corresponding to the visual representation is at or below threshold score (sometimes referred to herein as a “hint” threshold.

The visual representation 204f can remain highlighted and the target language transcription 206 can remain visible until the user has indicated an understanding of the meaning of the audio form. In some implementations, the user can indicate that the meaning of the audio form is understood by clicking on the corresponding visual representation 204f with a mouse or other pointing device.

The evaluation module 140 can receive input from the user of the computing device via the network 105. For example, the evaluation module 140 can determine which visual representation 204 has been selected by the user, and can then determine whether the selected visual representation 204 correctly matches the audio form presented to the user of the computing device. In some implementations, the evaluation module 140 can adjust a “known score” for the relevant audio form/visual representation pair, which is a numerical value assigned in response to determining whether the user selected the correct visual representation 204. Also, in some implementations, the evaluation module 140 can adjust and display a “game score” 210, a numerical value which may be equal to or distinct from the “known score”, and may or may not be related to it.

The evaluation module 140 can communicate with the audio form module 135 and the visual representation module 130. For example, if the evaluation module 140 determines that the user has selected an incorrect visual representation 204, the evaluation module 140 can communicate the error to the visual representation module 130, allowing the visual representation module 130 to help the user (e.g., by highlighting the correct visual representation 204f). In another example, if the user selects the correct visual representation, the evaluation module 140 can communicate with the audio form module 135, which can respond by presenting a new audio form to the user of the computing device 120.

After the user selects the correct visual representation 204 corresponding to the audio form that has been presented, the audio form module 135 can select a second audio form to be presented to the user as described above. The second audio form can be randomly selected by the audio form module 135. In some implementations, the second audio form can be the same as the first audio form. In other implementations, the second audio form can be different from the first audio form. For example, as shown in FIG. 2B, the second audio form can correspond to the instructional language phrase “an absent minded professor.” The target language transcription 206 “un professor distraido” can be displayed to show the user how the audio form appears in written form in the target language. In some implementations, the visual representation module 130 can highlight the corresponding visual representation 204e, as shown in FIG. 2B.

Again, the prompt 208 can be displayed asking the user to click on the visual representation of the audio form that has been presented. After the user responds by selecting a visual representation 204, the evaluation module 140 can determine whether the selection is correct, and can accordingly adjust the known score for this audio form/visual representation pair, and can also adjust and display the game score 210, which may be equal to or distinct from the known score, and may or may not be related to it. If the selection is incorrect, the visual representation module 130 can highlight the correct visual representation in order to assist the user. If the selection is correct, the audio form module 135 can present a third audio form.

The data processing system 110 can use the graphical interface 200 to present target language audio forms and visual representations 204 to the user in Mode 1. In some implementations, audio forms may be repeated any number of times in Mode 1. For example, if the evaluation module 140 determines that the user is having trouble correctly identifying the visual representation 204 that corresponds to a particular audio form, then that audio form can be presented repeatedly until the evaluation module 140 determines that the user has an adequate understanding of the meaning of the audio form. The evaluation module 140 can determine the user's level of understanding of a particular audio form (e.g., to provide a known score corresponding to the form) based on the number of times the user selects the correct visual representation 204, the ratio of correct selections to incorrect selections, the average time the user takes to select the correct visual representation 204, or other factors.

Also, when the evaluation module 140 determines that a user's level of understanding of a particular audio form is sufficiently high (e.g., by determining if the user's know score or other proficiency metric corresponding to the form is above a threshold score) then, in some implementations, the discourse selection module 125 can alter a discourse by replacing the instructional language text and/or images in the visual representation with a direct target language transcription of the target language audio form. This enables the user who already understands target language words aurally to gain exposure to these words in their written forms, and in this way develop reading ability in the target language.

In some embodiments, the evaluation module 140 may repeat the above determination, e.g., at regular intervals to determine if the user's performance has degraded (e.g., the user has forgotten the instructional language meaning of a target language audio form). If the user's performance has degraded, the alteration of the discourse can be undone, such that the instructional language text or image is again provided until the user regains adequate proficiency.

At the completion of Mode 1, the user should be able to comprehend the various target language words, phrases, or sentences corresponding to the visual representations 204, which take the form of instructional language text or images. When the evaluation module 140 determines that the user has a sufficient level of understanding (e.g., by determining when the user's known score or other proficiency metric for some or all of the visual representations 204 are above a threshold value), the data processing system 110 can present information to the user in a second mode (“Mode 2”).

In Mode 2, the data processing system again transmits the graphical user interface 200 to the computing device 120. As shown in FIG. 2C, the graphical user interface 200 includes a number of visual representations 204. The visual representation module 130 can select some or all of the same visual representations 204 that were displayed in Mode 1. In some implementations, the visual representation module 130 can select a random order for the visual representations 204 to be displayed. The visual representations 204 are consecutive portions of a discourse. Therefore, the visual representation module 130 can ensure that the order in which the visual representations 204 are displayed initially is not the same order in which they occur in the discourse.

The audio form module 135 can begin Mode 2 by selecting the audio form corresponding to the first visual representation in the discourse, or portion of a discourse, that is displayed on the graphical user interface. For example, in FIG. 2C, the first term in the discourse portion shown is “a barber” 204c. The audio form module 135 can transmit this audio form to the computing device 120. As discussed above, a target language transcription 206 can be displayed as the audio form is presented, in order to allow the user to see the audio form written in the target language, and thus better grasp the pronunciation.

The prompt 208 asks the user to arrange the visual representations 204 to form a sentence. In some implementations, the graphical user interface 200 also includes a word box 212. The user can respond to the prompt 208 by selecting the visual representation 204c corresponding to the audio form and dragging it onto the word box 212. This process is illustrated in FIG. 2D, which shows that the correct visual representation 204c has been selected and is being dragged toward the word box 212. FIG. 2E shows the correct visual representation 204c aligned with the word box 212. As shown, the word box 212 can be highlighted to indicate that the correct word has been selected.

The evaluation module 140 can determine whether the correct visual representation 204 has been selected, and can accordingly adjust the known score for the relevant audio form/visual representation pair, and also adjust the game score 210, which may be equal to or distinct from the known score, and may or may not be related to the known score. After the correct visual representation 204 has been selected, the audio form module 135 transmits to the computing device 120 the audio form corresponding to the second visual representation in the discourse that is displayed on the graphical user interface. The visual representation 204 that was correctly identified remains in place at the beginning of the sentence, and the word box 212 is displayed to the right-hand side of the correctly identified visual representation 204 as shown in FIG. 2F. Also as shown in FIG. 2F, the correctly identified visual representation 204 can be displayed with punctuation (i.e, the comma after the instructional language term “A barber”, and the capitalization of this term's first letter), so that the sentence can be more easily read as additional visual representations 204 are arranged in the correct order.

Next, the second audio form is presented, along with its target language transcription 206. The user can then respond to the prompt 208 by selecting, and dragging to the word box 212, the visual representation 204a corresponding to the second audio form, as shown in FIG. 2G. The evaluation module 140 determines whether the correct visual representation 204a has been selected, and can accordingly adjust the known score, and also the game score 210, which may be equal to or distinct from the known score, and may or may not be related to it. The process of Mode 2 repeats with each successive audio form, and the user is asked to construct the sentence one visual representation 204 at a time. As shown in FIG. 2H, the correctly identified visual representations 204 are combined to create the sentence until the last visual representation 204d is identified correctly.

At the end of Mode 2, the user can be given an opportunity to hear and read again the entire sentence that has been created in Mode 2. For example, as shown in FIGS. 21-2L, the entire sentence 209 that the user has constructed is displayed. The corresponding audio forms are now replayed, in the same order in which they were previously played. The pace of replay can be chosen by the user (for example by the positioning of a slider), so that the sentence plays at a tempo as close to (or far from) fluent as the user desires. As each target language audio form is played, its corresponding visual representation can be visually indicated (for example by highlighting or changing of color for the duration of the corresponding audio). This is shown in FIG. 2I for the visual representation “a barber”; in FIG. 2J for the visual representation “a bald man”; in FIG. 2K for the visual representation “and”; and in FIG. 2L for the visual representation “an absent-minded professor”.

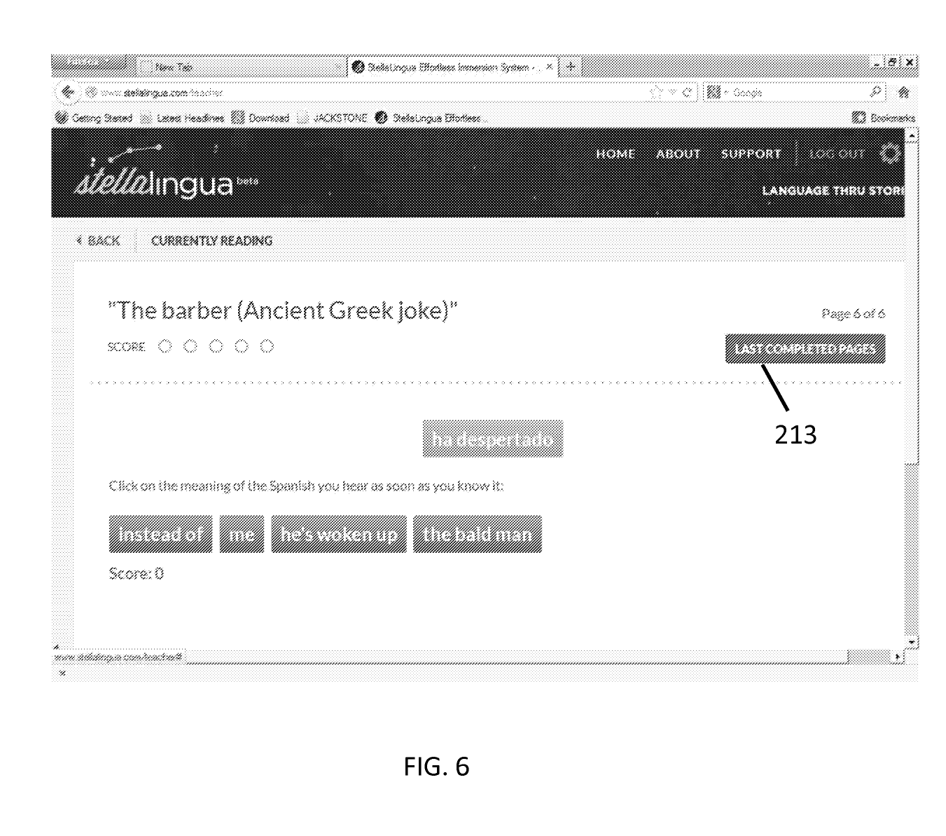

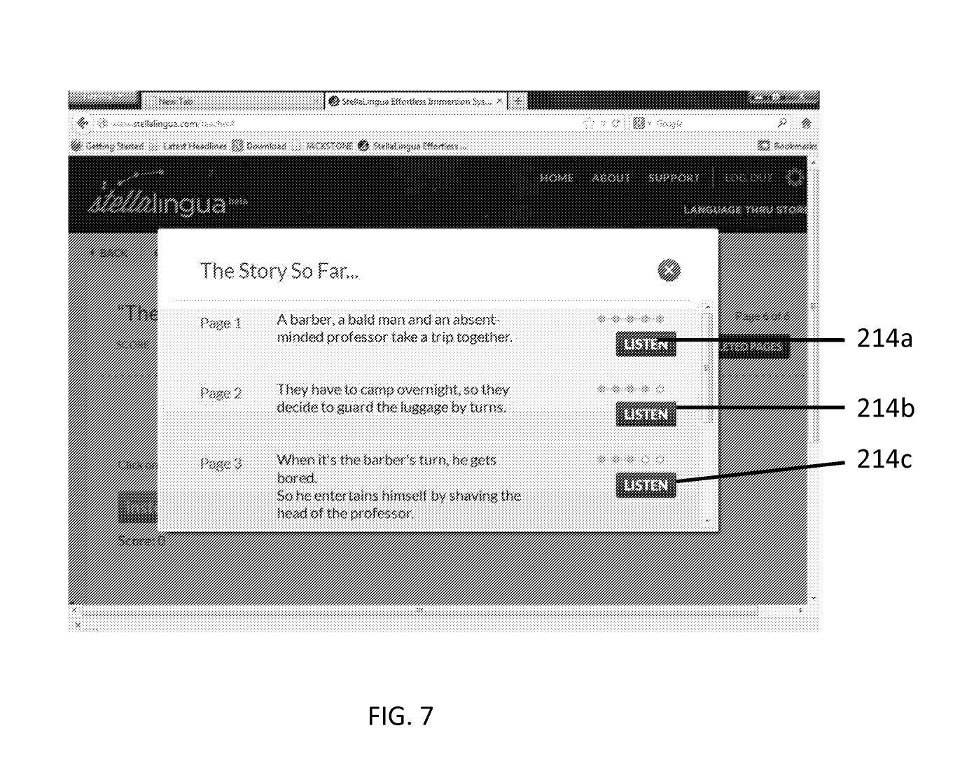

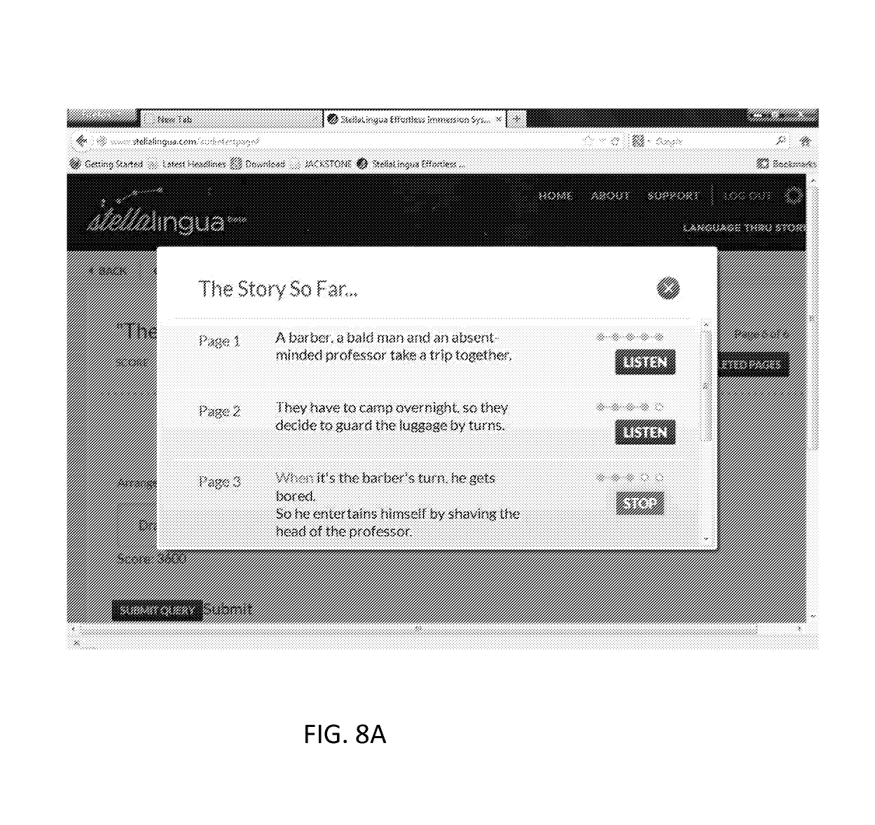

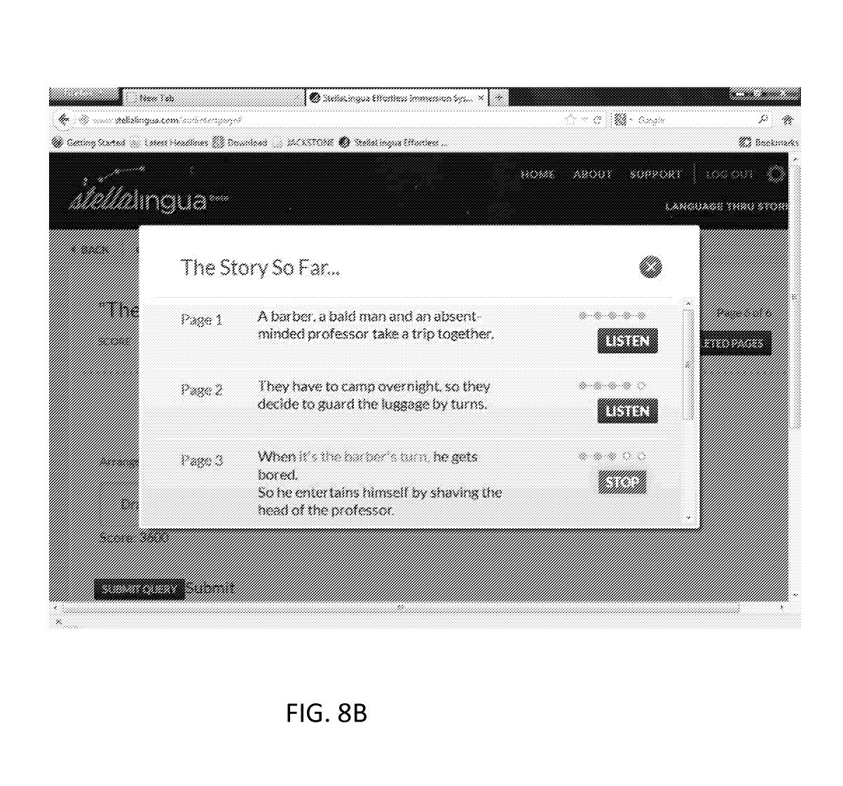

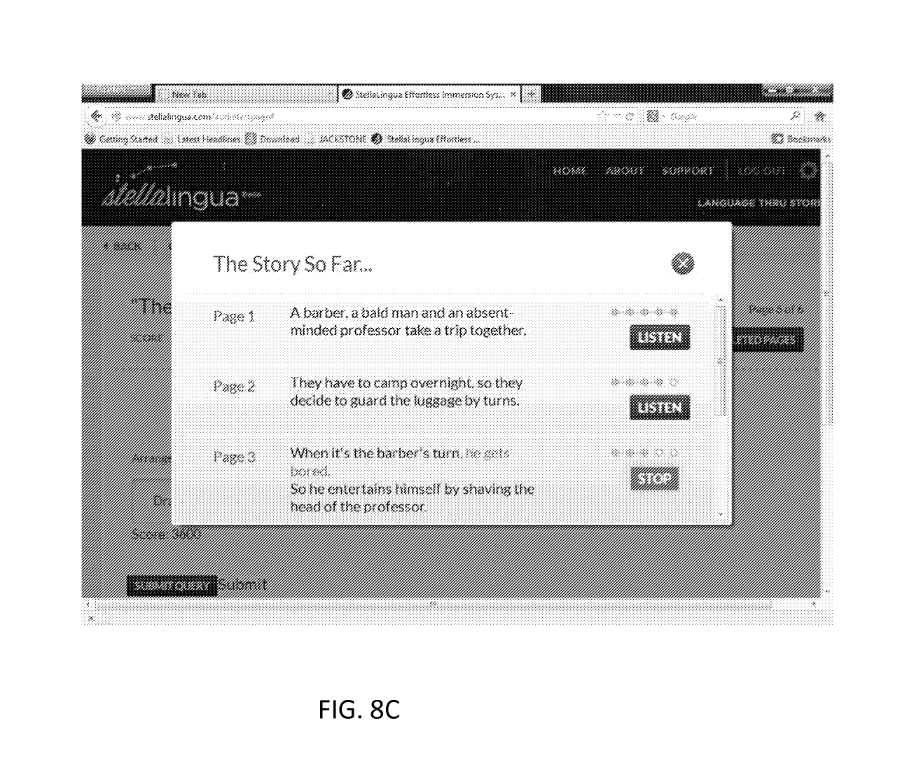

Also, once the user has completed one or more sentences in a discourse, then, at any time during either of Modes 1 or 2, the user can be given opportunities to hear and read again any of the discourse's prior sentences. For example, as shown in FIG. 6, an element or control 213 (in this example, bearing the words “last completed pages”) can be present in the graphical user interface that, when clicked on, allows the user to select, as shown in FIG. 7, from among already-completed sentences by clicking on one of the elements bearing the word “listen” 214. If the user selects an already completed sentence, for example by clicking on 214c, then that sentence's target language audio forms can be replayed, at a tempo chosen by the user (for example by positioning a slider). As each target language audio form is played, its corresponding visual representation can be visually indicated (for example by highlighting or changing of color for the duration of the corresponding audio). This is shown in FIG. 8A for the visual representation “when”; in FIG. 8B for the visual representation “it's the barber's turn”; and in FIG. 8C for the visual representation “he gets bored.” Thus, as the data processing system 110 progresses through Mode 1, audio forms and visual representations 204 are presented to the user so that the user can store the target language words, phrases, and sentences, and their meanings, in short-term memory. The data processing system 110 then commences Mode 2, in which the user is asked to assemble the content stored in short-term memory in Mode 1 into a sentence or group of sentences. If there are additional sentences or groups of sentences in the discourse, the data processing system 110 can present them to the user iteratively according to the Mode-1 and Mode-2 processes described above.

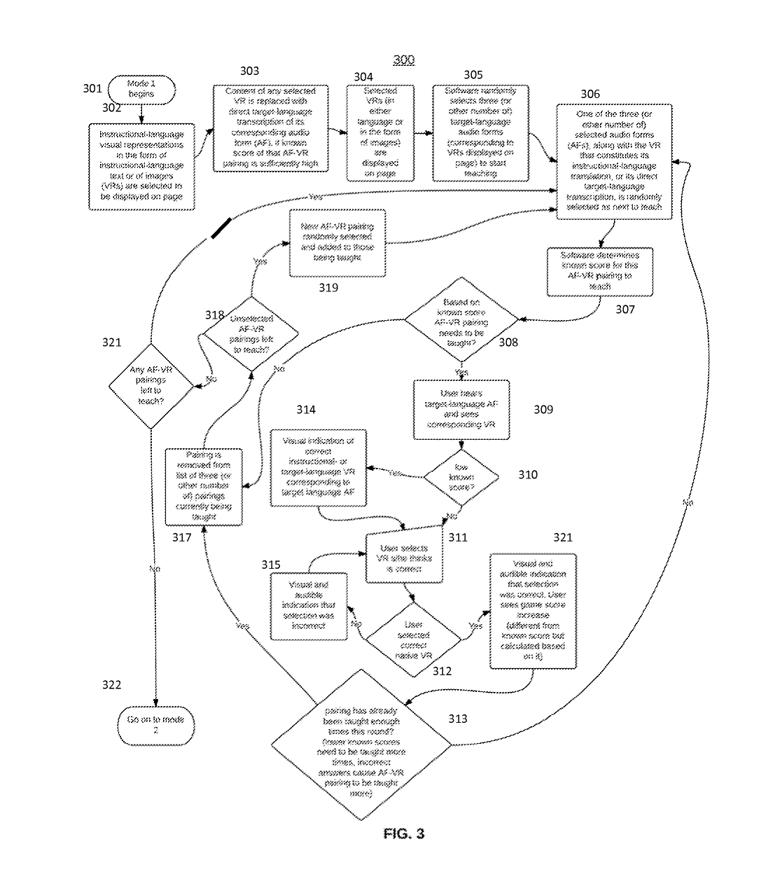

FIG. 3 is a block diagram of a method 300 for teaching a user of a computing device to store a limited number of target language words, phrases, and/or sentences in short-term memory, according to an illustrative implementation. In some implementations, the method 300 corresponds to Mode 1 as discussed above in connection with FIGS. 2A-2B. Mode 1 is entered in step 301. For example, the method 300 can include the step 302 of selecting visual representations in the form of instructional language text, or of images, to be displayed. Also, for each selected visual representation, the method 300 can include the step 303 of determining whether the content of the visual representation can be replaced with a direct target language transcription of the corresponding audio form. For example, this decision can be made based on the known score determined for this audio form/visual representation pair. In some implementations, a comparison can be made between the determined known score and a threshold value. For example, if the known score is above the threshold value (i.e. the user has a sufficiently high level of understanding), it can be determined that the content of the visual representation can be replaced with a direct target language transcription of the audio form. In contrast, if the known score is below the threshold value (i.e. the user does not have a sufficiently high level of understanding), it can be determined that the content of the visual representation cannot be replaced with a direct target language transcription of the audio form. If it is determined that the content of the visual representation can be replaced with a direct target language transcription of the audio form, then the method 300 can include the step of replacing the content of the visual representation with a direct target language transcription of the audio form. If it is determined that the content of the visual representation cannot be replaced with a direct target language transcription of the audio form, then no such replacement is made.

The method 300 also includes the step 304 of displaying selected visual representations. In some implementations, the visual representations are displayed on a graphical user interface on a computing device. A visual representation can be an image, a video, text in the instructional language, or any other type of visual form that conveys the meaning of a word, phrase, or sentence in the target language in a way that the user can easily comprehend. For users who have a sufficiently high understanding of a given target language audio form, the corresponding visual representation can be text in the target language, i.e. a direct transcription of the audio form. In some implementations, the visual representations are displayed in a random order within the graphical user interface. For example, the visual representations can all belong sequentially as part of the discourse, but can be presented randomly in order to separate the individual meanings of the visual representations from the meaning of the discourse as a whole. Therefore, the user can learn the meanings of individual words, phrases, and/or sentences in the target language and commit them to short-term memory before applying the newly learned meanings to understand the discourse.

The method 300 can include the step 305 of selecting, e.g., three audio forms to start teaching, which correspond to three of the displayed visual representations (in other embodiments any other suitable number of audio forms may be used). For instructional language or image-based visual representations, these audio forms can be target language translations. For target language visual representations, these audio forms can be target language pronunciations. Each audio form can be presented aurally (“played”) to the user. In some implementations, the audio forms to be taught are randomly selected. In some implementations, a different number of audio forms can be selected to start teaching. For example, the method 300 could include a step in which only one or two audio forms are selected to start teaching, or in which more than three audio forms are selected to start teaching.

The method 300 can include the step 306 of selecting a single audio form and its accompanying visual representation from among the three (or other number) selected in the previous step. For this audio form/visual representation pair, the method 300 can include the step 307 of determining a “known score” corresponding to the user's knowledge level. A known score can be information (such as a numerical value) indicating the user's level of understanding of the audio form/visual representation pair. For example, if the user has never been taught this audio form/visual representation pair, a relatively low known score can be determined. If the user has indicated some level of knowledge of this audio form/visual representation pair in the past, a relatively high known score can be determined. The method 300 can include the step 308 of determining whether the selected audio form/visual representation pair must be taught. For example, this decision can be made based on the known score determined for this audio form/visual representation pair. In some implementations, a comparison can be made between the determined known score and a threshold value (possibly distinct from the threshold value discussed above in connection with whether the content of a visual representation can be replaced by a target language transcription). For example, if the known score is below the threshold value (i.e., the user has a low level of understanding), it can be determined that the audio form/visual representation pair must be taught. In contrast, if the known score is above the threshold value (i.e., the user has a high level of understanding), it can be determined that the audio form/visual representation pair does not need to be taught. If it is determined that there is no need to teach the selected audio form/visual representation pair, the method 300 can proceed to a step 317 such that pair can be removed from the group of three (or other number of) pairs that were previously selected. Then the method 300 can include the step 318 of determining whether there are additional audio form/visual representation pairs left to teach that are not among the three (or other number of) pairs that were previously selected to be taught, but that are among those pairs whose visual representations are displayed on the graphical user interface. If there are such pairs left to teach, then the method 300 can include the step 319 of selecting one of these pairs at random and adding it to the remainder of the three (or other number of) audio form/visual representation pairs previously selected to be taught (e.g., by returning to step 306). Then one of the three (or other number of) audio form/visual representation pairs that have been selected to be taught can be randomly chosen as the next one to teach. The process of determining a known score can then be repeated for this randomly chosen audio form/visual representation pair.

Alternatively, if it is determined that the audio form/visual representation pair must be taught, the method 300 can include the step 309 of audibly presenting the audio form to the user, e.g. such that the user hears the audio form while seeing the corresponding visual representation. The method 300 can also include the step 310 of determining whether the known score is sufficiently low that the user needs assistance to select the correct visual representation after hearing the audio form. If the known score is low enough, the method 300 can include the step 314 of, e.g., visually indicating the correct visual representation, whether this representation takes the form of instructional language text or an image, corresponding to the target language audio form. For example, the visual indication can include highlighting the correct visual representation.

If the known score is high enough that the user does not require additional assistance, no visual indication will be provided and the method 300 will proceed directly from the step 310 to the step 311 discussed below.

The method 300 also includes the step 311 of recording the user's selection of the visual representation the user believes corresponds to the audio form, and the step 312 of determining whether the selection was correct. For example, in some implementations, the user can select a visual representation by clicking on it with a mouse or other pointing device, and the click can be detected by a computer. In various embodiments, any other suitable input interface may be used including, e.g., a keyboard, touch pad, or touch screen.

If it is determined that the user's selection was incorrect, the method 300 can include the step 315 of visually and/or audibly indicating that the selection was incorrect, and the user can be prompted to select another visual representation. In this circumstance the method 300 can also include the optional step (not shown) of visually and/or audibly indicating the correct visual representation so that the user can then select that correct visual representation and better learn this particular audio form/visual representation correspondence.

If the user has selected the correct visual representation, the method 300 can include the step 321 of visually and/or audibly indicating this correct selection and increasing the user's known score for this audio form/visual representation pair. In addition, in some embodiments, a “game score” can be displayed to the user. In some implementations, the displayed game score may be equal to the known score used throughout the method 300 to determine whether the audio form/visual representation pair must be taught or whether the user requires additional assistance (e.g., a visual indication) in order to correctly identify the visual representation corresponding to the audio form. In other implementations, the game score and known score may differ from each other. If they do differ from each other, they may be related to each other. The method 300 may proceed from the step 321 to the step 313 discussed below.

The method 300 can also include the step 313 of determining whether the audio form/visual representation pair has been taught a sufficient number of times. For example, if the known score for the audio form/visual representation pair is relatively low, it can be determined that the audio form/visual representation pair has not been taught enough times. The method 300 can then repeat the step 316 of randomly choosing one of the three (or other number of) previously selected audio form/visual representation pairs to teach.

If instead it is determined that the audio form/visual representation pair has been taught enough times, the, in the step 317, that pair can be removed from the group of three (or other number of) pairs that were previously selected. The method 300 can then repeat the step 318 of determining whether there are additional audio form/visual representation pairs to teach that are not among the three (or other number of) pairs that were previously selected to be taught, but that are among those pairs whose visual representations are displayed on the graphical user interface.

If there are such pairs left to teach, the method can repeat the steps 319, 306 of selecting one of these pairs at random and adding it to the three (or other number of) pairs that were previously selected to be taught. Then the method 300 can proceed to the step 306 of choosing a single audio form/visual representation pair from among the three (or other number of) pairs that have been selected to be taught, and determining whether this pair should be taught based on its associated known score (steps 307 and 308).

When there are no remaining pairs to be taught that are not among the three (or other number of) pairs that were selected to be taught, but that are among those pairs whose visual representations are displayed on the graphical user interface, the method 300 can include the step 321 of determining whether there are pairs remaining to be taught that are among the three (or other number of) pairs that have been selected to be taught. If there are additional pairs to be taught that are among those that have already been selected to be taught, the method 300 can repeat the steps 306-208 of selecting one of these pairs at random and determining whether this pair should be taught based on its known score. When there are no remaining pairs to be taught, the method 300 proceeds to the step 322 of terminating.

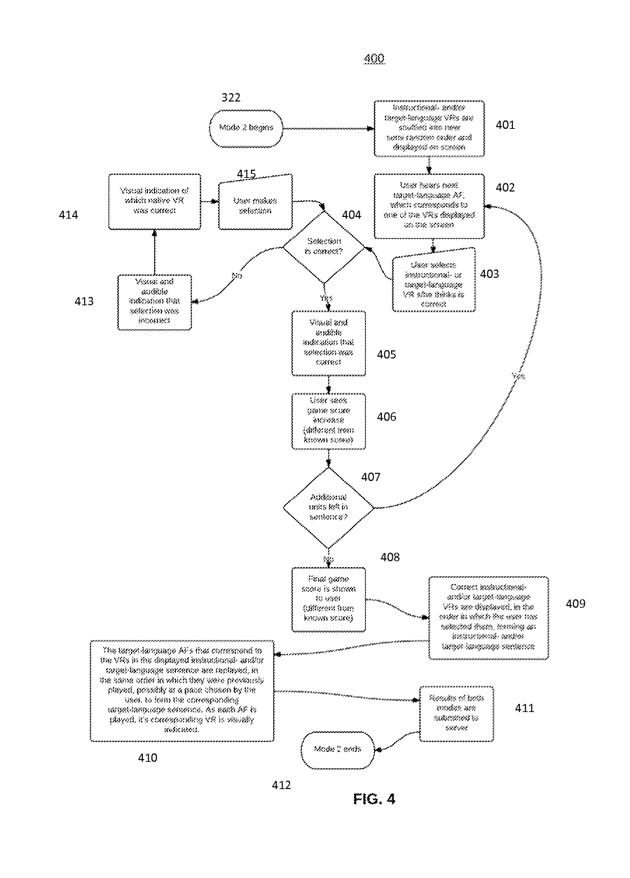

FIG. 4 is a block diagram of a method 400 for teaching a user to construct a discourse, or portion of a discourse, composed of the target language words, phrases, or sentences stored in short-term memory in the method of FIG. 3, according to an illustrative implementation. The method 400 can proceed from the termination step 322 of the method 300 shown in FIG. 3. The method 400 can include the step of 401 selecting a random (or otherwise scrambled) order in which to display to the user the visual representations corresponding to the words, phrases or sentences stored in short-term memory in the method of FIG. 3. The randomness or scrambled nature of this order can be constrained to prevent visual representations from being ordered in ways that are similar to the order in which they will be placed by the user to form a discourse. For example, in this step 401 the method 400 might be constrained to select an order in which no visual representation follows another visual representation consecutively if it also follows that visual representation consecutively in the order in which it will be placed by the user to form a discourse.

The method 400 can include the step 402 of aurally presenting an audio form to the user (e.g., such that the user hears target language audio form corresponding to one of the visual representations n display). The audio form presented can correspond to the next word, phrase or sentence in the discourse or discourse portion. For example, at the beginning of the method 400 (e.g. in a first iteration), the audio form can be presented that corresponds to the first word, phrase or sentence of the discourse or discourse portion. Other audio forms can subsequently (e.g., in later iterations) be presented in the order in which they appear in the discourse or discourse portion.

The method 400 can include the step 403 of recording the user's selection of the visual representation the user believes corresponds to the audio form, and the step 404 determining whether the selection was correct. For example, in some implementations, the user can select a visual representation by clicking on it with a mouse or other pointing device, and the click can be detected by a computer. If it is determined that the user's selection was incorrect, the method 400 can proceed to the step 413 of visually and audibly indicating that the selection was incorrect, and of decreasing the user's known score for this audio form/visual representation pair. The correct visual representation can then be highlighted in the step 414, and the user can again be prompted to select the correct visual representation in the step 415. The method 400 then returns to the step 404 to determine if the new selection is correct.

If the user selects the correct visual representation as determined in the step 404, the method 400 can include the step 405 of visually and audibly indicating the correct selection and increasing the user's known score for this audio form/visual representation pair. In addition, in the optional step 406 a game score can be increased and displayed to the user. The game score may be equal to or distinct from the known score, and may or may not be related to it. Also, in some embodiments, as a result of having been correctly selected by the user, the visual representation can be placed in its proper location relative to other visual representations in the discourse.

The method 400 also includes the step 407 of determining whether there are additional words, phrases or sentences left on the graphical user interface that have not been selected by the user and incorporated into the discourse or discourse portion. If there are, the method 400 can repeat the step 402 of selecting the next audio form in the discourse or discourse portion and presenting it to the user, and can then proceed through the subsequent steps as described above. If there are no additional words, phrases or sentences left on the graphical user interface (i.e., the user has correctly identified all of the visual representations in their correct order to form the discourse or discourse portion), the method 400 can proceed to the optional step 408 of displaying a final game score to the user. The displayed game score can be a numerical value, which may be equal to or distinct from, and may or may not be related to, the known scores that have been calculated based on the user's level of mastery of the target language words, phrases, and/or sentences on the graphical user interface.

The method 400 can also include the optional step 409 of letting the user hear and read again the entire discourse or discourse portion (e.g. a sentence) that has been created in the method 400. For example, the entire “sentence” of visual representations that the user has constructed can be visually displayed, and its corresponding target language audio forms can be replayed, in the same order in which they were heard previously, with the pace of replay chosen by the user. As each audio form is played, its corresponding visual representation can be visually indicated.

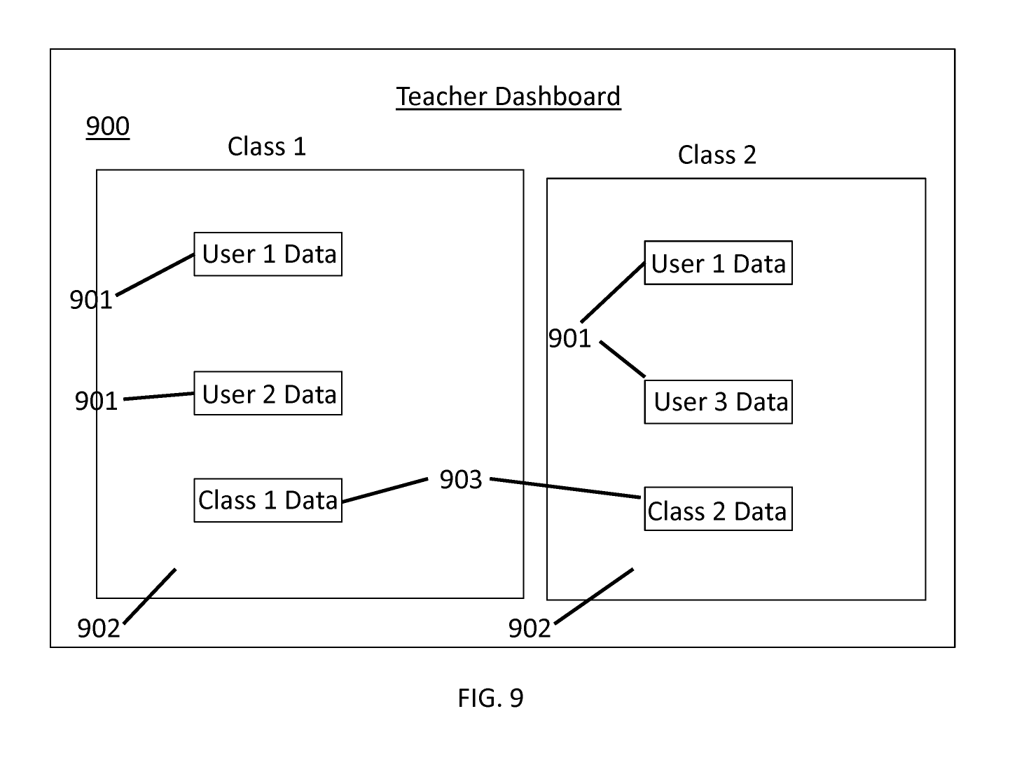

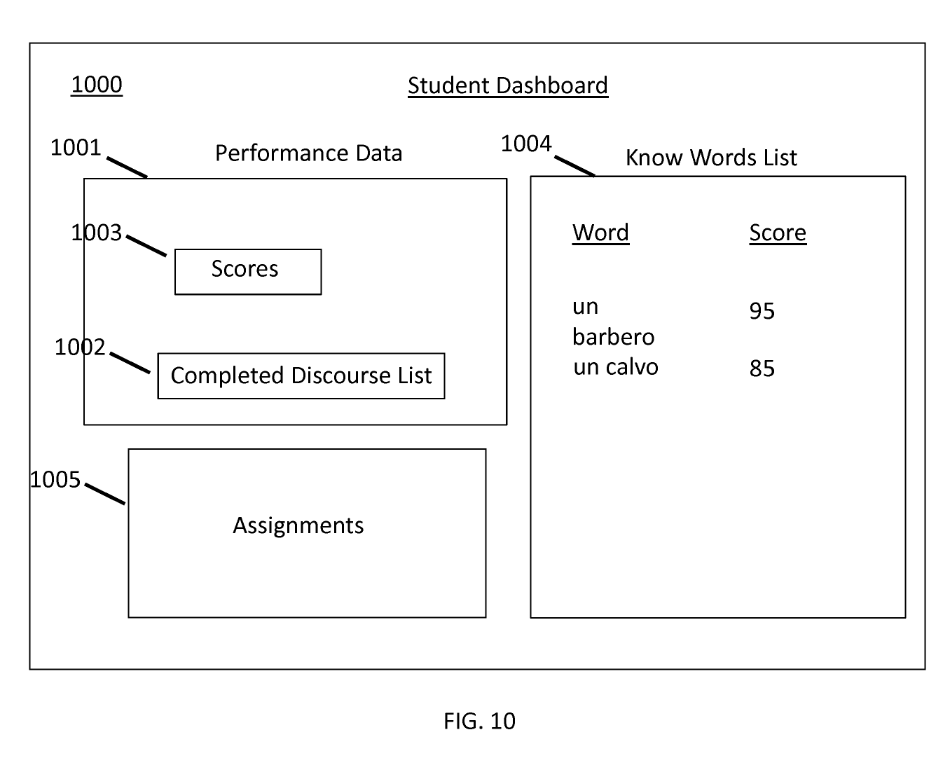

The method 400 can also include the step 410 of submitting the results of the method 400 and the method 300 to a computer, such as a server. The results can then be stored by the computer for later retrieval (e.g., to be used in generating the teacher dashboard 900 shown in FIG. 9 or the user page 1000 shown in FIG. 10).

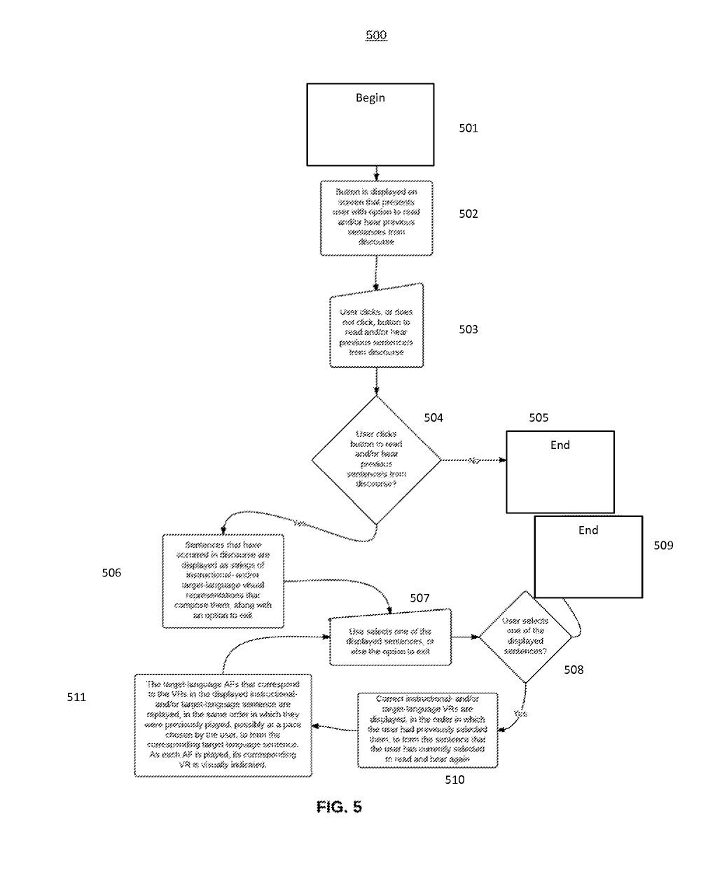

In addition, either or both of methods 300 and 400 can include the process 500 as shown in FIG. 5 for allowing the user to hear and read again prior sentences (or other discourse portions) in the discourse by selecting them from a list of such sentences. For example, the user can be given the option to cause to be displayed the visual representations that compose prior sentences of the discourse. The user can be permitted to select from among these sentences any that he or she wishes to hear and see replayed. For any of these sentences that the user selects, the entire “sentence” of visual representations that the user has constructed can be visually displayed, and its corresponding target language audio forms can be replayed, in the same order in which they were heard previously, with the pace of replay chosen by the user. As each audio form is played, its corresponding visual representation can be visually indicated.

For example, as show, the method 500 begins at step 501 (e.g., triggered by the user, or by the completion of any suitable step in method 300 or method 400). The method 500 then proceeds to the step 502 where a button is displayed that presents the user with the option to read and/or hear previous sentences (or other portions) from a discourse. In the step 503, the user click or chooses not to click the button. In the step 504, the method 500 determines if the user has clicked the button.

If the user has not clicked the button, the method 500 may terminate. If the user has clicked the button, in the step 506 sentences (or other portions) of the discourse may be displayed as strings of instruction language and/or target language visual representations that compose them. An option to exit may also be displayed.

In step 507, the user selects one of the displayed sentences, or the exit options. In step 508, the method 500 determines if the user has selected one of the displayed sentences or the exit option. If the exit option has been selected, the method 500 terminates at the step 509.

If one of the sentences has been selected, the method 500 proceeds to the step 510 of displaying correct instructional language and/or target language visual representations for the selected sentence. The visual representations may by displayed in the order in which the user had previously selected (e.g., in Mode 1 or Mode 2) them to for the currently selected sentence.

The method 500 may then proceed to the step 511, in which the target language audio forms that correspond to the instructional language and/or target language visual representations visual representations in the displayed sentence may be replayed. In some embodiments, the audio forms are played in the same order in which they were previously played (e.g., in Mode 1 or Mode 2). As each audio form is played, the corresponding visual representation may be visually indicated (e.g., highlighted). In some embodiments, the tempo at which the audio forms are played may be selected by the user.

Following the step 511, the method 500 may return to the step 507 allowing the user to select additional sentences or to exit the method 500.

Referring to FIG. 9, in some embodiments, the processor 110 may generate an interactive teacher dashboard 900 to be displayed on a computing device such as computing device 120 or a separate device (not shown in FIG. 1).

An instructor may access the teacher dashboard 900, e.g. via a password protected login, to review information about one or more of the users of the system 100. For example, as shown, user data 901 is shown for three users (User 1, User 2, and User 3). The user data 901 may include any suitable information about the user including, e.g., discourses or portions thereof completed, known scores for discourses or portions thereof completed, known scores for verbal units, average known score for a user, game scores, known verbal units (e.g., words or phrases for which a user has attained a known score above a threshold value), total number of verbal units the user has been exposed to, comparison of user performance in Mode 1 versus user performance in Mode 2, etc.

In some embodiments, in order to keep track of how much each student is focusing on the educational content when using the system 100, the teacher dashboard 900 may include features that indicate how many responses (e.g., clicks) each user makes during a given session, and also how many of these clicks are correct, and how many are incorrect. If one user is making far fewer responses than other users, then the instructor can tell that the user may not be using the system 100 as often as the instructor desires. Similarly the dashboard 900 may indicate when the user is using (e.g., logged into and/or actively responding to) the system 100.

The dashboard 900 may also indicate the ratio of correct responses to incorrect responses for a given user. If a user makes the expected amount of responses or more, but makes a larger number of incorrect responses than the other users, the dashboard 900 may alert the teacher to the possibility that the user is just randomly making responses (e.g., randomly clicking), without thinking about what anything means, until the user happens make the correct response by chance alone. The instructor can then go investigate to find out whether this is the case.

As noted above, the teacher dashboard 900 may display user data 901 including comparison of user performance in Mode 1 (i.e. when the system 100 is teaching words/phrases) versus user performance in Mode 2 (i.e. when the system 100 is prompting the user to construct a longer structure such as a sentence). In some embodiments, this may be beneficial as the information could be used to determine if a user is ignoring audio information (e.g., if a student is not using the headphones or not turning on the sound) because such a situation may be indicated by a high number of correct responses in Mode 1, but a comparatively large number of incorrect responses in Mode 2 (since the user would lack the benefit of hearing the words).

In some embodiments, the users may be grouped into any number of classes 902, e.g., as shown two classes are used (Class 1 containing Users 1 and 2 and Class 2 containing Users 1 and 3). Aggregate class data 903 for one or more of the classes 902 may be compiled by the processor 125 and provided on the dashboard 900.

In some embodiments, the instructor can use the teacher dashboard 900 to group users into classes 902 and assign lessons to the users in each class 902. The lessons can be in the form of a selection of components of content including pages, chapters, stories, or a number of verbal units that must be completed by each user within a certain amount of time. The instructor can track each user's progress by accessing information (e.g., a user summary page) which indicates the components of content (pages, chapters, stories, and/or number of verbal units) a user has completed in a selectable time period.

In some embodiments, the system 100 may monitor the timing of a user's responses and provide a report to the instructor through the teacher dashboard 900. For example, if the user enters responses very quickly (e.g., within a second of each other or less), it may indicate that that the user is simply responding (e.g., clicking) randomly, and is not actually engaging the instructional material presented to the user.

Referring to FIG. 10, in some embodiments, the processor 110 may generate an interactive user page 1000 to be displayed on a computing device such as computing device 120. The user page 1000 may include any suitable information about the user including, e.g., discourses or portions thereof completed, known scores for discourses or portions thereof completed, known scores for verbal units, the average known score for a user, game scores, known verbal units (e.g., words or phrases for which a user has attained a known score above a threshold value), the total number of verbal units the user has been exposed to, comparisons of user performance in Mode 1 versus user performance in Mode 2, etc. As shown, the user page 1000 includes performance data 1001 including a list of discourses or portions thereof completed 1002 and scores for the discourses or portions thereof completed 1003. The user page 1000 also includes a “known words list” 1004 including a list of words or phrases for which a user has attained known scores above threshold value.

In some embodiments, assignments 1005 may be displayed. In some embodiments the assignments 1005 displayed may include, e.g., class assignments made by an instructor using the teaching dashboard 900.

Although the example provided above describe teaching systems and methods using audio and visual components, in other embodiments the audio component of the method may be omitted (e.g., in instances where a user interface is incapable of producing sound). In some embodiments, the teaching systems and methods may allow the user to select a visual only mode or an audio/visual mode.

While various inventive embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

A computer employed to implement at least a portion of the functionality described herein may comprise a memory, one or more processing units (also referred to herein simply as “processors”), one or more communication interfaces, one or more display units, and one or more user input devices. The memory may comprise any computer-readable media, and may store computer instructions (also referred to herein as “processor-executable instructions”) for implementing the various functionalities described herein. The processing unit(s) may be used to execute the instructions. The communication interface(s) may be coupled to a wired or wireless network, bus, or other communication means and may therefore allow the computer to transmit communications to and/or receive communications from other devices. The display unit(s) may be provided, for example, to allow a user to view various information in connection with execution of the instructions. The user input device(s) may be provided, for example, to allow the user to make manual adjustments, make selections, enter data or various other information, and/or interact in any of a variety of manners with the processor during execution of the instructions.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03

1. A method for teaching a target language to a user comprising:
(i) selecting visual representations from a visual representation database corresponding to instructional-language text or images to be displayed on a user interface device;
(ii) generating one or more instructions configured to cause the user interface device to display instructional language text or images based on the selected visual representations;
(iii) selecting target language audio forms from an audio form database corresponding to respective ones of the selected visual representation;
(iv) generating one or more instructions configured to cause the user interface device to play one of the selected audio forms;
(v) receiving a user selection of a visual representation from the user interface device; and
(vi) determining if the user selection of the visual representation correctly corresponds to the audio form played in step (iv).

2. The method of claim 1, further comprising, based on the determination in step (vi):
adjusting a user known score corresponding to a selected visual representation and a respective audio form; and
generating instructions to cause the user interface device to produce an audio or visual indication of whether the user selection of the visual representation correctly corresponds to the audio form played in step (iv).

3. The method of claim 2, further comprising:
prior to step (ii), for each of the selected visual representations, determining whether a respective user known score for the visual representation is above a replacement threshold; and
for selected visual representations having respective user known scores above a replacement threshold, modifying the instructions generated in step (ii) to cause the corresponding instructional-language text or images to be replaced with direct target language transcriptions.

4. The method of claim 3, further comprising:
iteratively repeating steps (iii) through (vi) wherein, for each iteration of step (v), the respective one of the selected audio forms is chosen by:
(a) identifying an initial audio form choice from the selected audio forms;
(b) determining if a user known score corresponding to the initial audio form and respective visual representation is below a teaching threshold;
(c) if the user known score corresponding to the initial audio form and respective visual representation is below a teaching threshold, playing the audio form; and
(d) if the user known score corresponding to the initial audio form and respective visual representation is not below a teaching threshold, selecting a different initial audio form choice from the selected audio forms and returning to step (b).

5. The method of claim 4, further comprising:
determining if a user known score corresponding to the audio form to be played in step (iv) is below a hint threshold; and
if a user known score corresponding to the audio form to be played in step (iv) is below the hint threshold, generating instructions to cause the user interface device to visually identify the respective visual representation while or after the audio form is played.

6. The method of claim 5, wherein iteratively repeating steps (iii) through (vi) further comprises:
monitoring a user known score for each of the selected visual representations and respective audio forms; and
ending the iterative repetition of steps (iii) through (vi) when the user known score for each of the selected visual representations and respective audio forms is above the teaching threshold.

7. The method of claim 6, wherein the user known score for each of the selected visual representations and respective audio forms is determined based on at least one selected from the list consisting of: the number of times the user correctly identifies the visual representation in response to the corresponding audio form; a speed at which the user correctly identifies the visual representation in response to the corresponding audio form; the number of times the user has heard the audio form; the amount of time that has lapsed since the last time the user has heard the audio form.

8. The method of claim 6, further comprising, after ending the iterative repetition of steps (iii) through (vi):
(vii) selecting a discourse portion from a discourse selection database, the discourse portion corresponding to a first set of visual representations in a respective correct order;
(viii) generating one or more instructions configured to cause the user interface device to display instructional language text or images corresponding to the first set of visual representations in a display order that is different from the respective correct order,
(ix) selecting target language audio forms from an audio form database corresponding to respective ones of the first set of visual representations;
(x) generating one or more instructions configured to cause the user interface device to play an audio form for a respective visual representation from the first set of visual representations;
(xi) receiving a user selection of a visual representation from the user interface device; and
(xii) determining if the user selection of the visual representation correctly corresponds to the audio form played in step (x).

9. The method of claim 8, further comprising:
based on the determination in step (xii):
adjusting a user known score corresponding to a pairing of a selected visual representation and a respective audio form; and
generating instructions to cause the user interface device to produce an audio or visual indication of whether the user selection of the respective visual representation correctly corresponds to the audio form played in step (x).

10. The method of claim 9, wherein the first set of visual representations may comprise one or more of the visual representations selected in step (i).

11. The method of claim 10, further comprising:
iteratively repeating steps (x)-(xii) wherein, if it is determined in a first iteration of step (xii) that the user selection of the visual representation correctly corresponds to the audio form played in the preceding step (x), in the next iteration a new audio form is selected for the next iteration of step (x) based on the correct order of the discourse portion.

12. The method of claim 10, further comprising ending the iterative repetition of steps (x)-(xii) when the user has correctly identified each visual representation of the first set of visual representations.

13. The method of claim 12, further comprising:
(xiii) selecting a second discourse portion from a discourse selection database, the second discourse portion corresponding to a second set of visual representations in a respective correct order,
(xiv) generating one or more instructions configured to cause the user interface device to display instructional-language text or images corresponding to the second set of visual representations in a display order that is different from the respective correct order,
(xv) selecting target language audio forms from an audio form database corresponding to respective visual representations of the second set of visual representations;
(xvi) generating one or more instructions configured to cause the user interface device to play an audio form for a respective visual representation from the second set of visual representations;
(xvii) receiving a user selection of a visual representation from the user interface device; and
(xviii) determining if the user selection of the visual representation correctly corresponds to the audio form played in step (xvi).

14. The method of claim 13, further comprising:
generating one or more instructions configured to cause the user interface device to display text or images corresponding to the first discourse portion and the second discourse portion;
receiving a user selection of the first discourse portion or the second discourse portion; and
generating instructions to cause the user interface device to review the selected discourse portion by sequentially displaying text or images based on the set of visual representations for the selected discourse portion in an order corresponding to the correct order.

15. The method of claim 14, further comprising playing the respective audio form for each of the visual representations during the step of sequentially displaying or otherwise visually indicating text or images based on the set of visual representations for the selected discourse portion in an order corresponding to the correct order.

16. The method of claim 15, wherein the first discourse portion and the second discourse portion are each sentences in a common discourse.

17. The method of claim 15, wherein playing the respective audio form for each of the visual representations during the step of sequentially displaying or otherwise visually indicating text or images based on the set of visual representations for the selected discourse portion in an order corresponding to the correct order comprises playing the respective audio forms and displaying the text or images at a user selected tempo.

18. The method of claim 1, wherein at least one of:
(a) the user interface device comprises at least one from the list consisting of: a cellular phone, a smart phone, a tablet computer, a laptop computer, a personal computer, and a television, and
(b) the instructional language is English and the target language comprises at least one from the list consisting of: Arabic, Spanish, French, German, Italian, Russian, Hindi, Japanese, and Chinese.

19. (canceled)

20. A non-transitory computer readable storage medium comprising instructions which when executed by a processor implements the steps of:
(i) selecting visual representations from a visual representation database corresponding to instructional-language text or images to be displayed on a user interface device;
(ii) generating one or more instructions configured to cause the user interface device to display instructional language text or images based on the selected visual representations;
(iii) selecting target language audio forms from an audio form database corresponding to respective ones of the selected visual representation;
(iv) generating one or more instructions configured to cause the user interface device to play one of the selected audio forms;
(v) receiving a user selection of a visual representation from the user interface device; and
(vi) determining if the user selection of the visual representation correctly corresponds to the audio form played in step (iv).

21-36. (canceled)

37. An apparatus for teaching a target language to a user comprising:
at least one processor in operative communication with a user interface device;
a visual representation database in operative communication with at least one processor; and
an audio form database in operative communication with at least one processor;
wherein, during operation the processor is configured to:
(i) select visual representations from a visual representation database corresponding to instructional-language text or images to be displayed on a user interface device;
(ii) generate one or more instructions configured to cause the user interface device to display instructional language text or images based on the selected visual representations;
(iii) select target language audio forms from an audio form database corresponding to respective ones of the selected visual representation;
(iv) generate one or more instructions configured to cause the user interface device to play one of the selected audio forms;
(v) receive a user selection of a visual representation from the user interface device; and
(vi) determine if the user selection of the visual representation correctly corresponds to the audio form played in step (iv).

38-51. (canceled)
